(19) United States
(12) Patent Application Publication
(10) Pub. No.: US 2019/0385160 A1
(43) Pub. Date: Dec. 19, 2019

(54) SYSTEM AND PROCESS FOR ON-THE-FLY CARDHOLDER VERIFICATION METHOD SELECTION

(71) Applicant: Mastercard International Incorporated, Purchase, NY (US)

(72) Inventors: Ilgin Safak, White Plains, NY (US); Niravkumar Pandya, Danbury, CT (US)

(21) Appl. No.: 16/012,222

(22) Filed: Jun. 19, 2018

(51) Int. Cl. G06Q 20/38; G06Q 20/32; G06Q 20/40

(52) U.S. Cl. CPC G06Q 20/3825; G06Q 20/3278; G06Q 20/3829; G06Q 20/40145; G06Q 20/3227; G06Q 20/3274

(57) ABSTRACT

Methods, apparatus and systems for permitting a cardholder to select a cardholder verification method (CVM) during a secure transaction. In an embodiment, a consumer mobile device running a mobile payment application receives, from a cardholder, selection of a payment account and an instruction to pay via one of contactless, barcode, SRC or digital secure remote payment (DSRP). The consumer mobile device then transmits a request for a secure transaction to a merchant device, receives a request for payment account data, displays a plurality of cardholder verification methods (CVMs), receives selection of a CVM, and prompts the cardholder to provide cardholder identification data in accordance with the selected CVM. The process also includes receiving and authenticating, by the consumer mobile device, the cardholder identification data from the cardholder, generating a cryptogram in accordance with the selected CVM, and transmitting transaction data including payment account data and the cryptogram to the merchant device.

### FIELD OF THE DISCLOSURE

Embodiments described herein generally relate to processes and systems that permit consumers to set a cardholder verification method (CVM) for digital payment transactions, and specifically to permit consumers using mobile devices to set the CVM for tokenized contactless and online transactions. Thus, systems and processes support selection of multiple CVM models within the same mobile device and/or digital wallet, mobile banking application (and the like), including on-the-fly CVM model selection by the consumer or cardholder (end-user) for tokenized contactless chip card transactions, magnetic stripe transactions, digital secure remote payment (DSRP) transactions, and Secure Remote Commerce (SRC) transactions with EMV-grade security.

### BACKGROUND

Portable electronic devices, such as smartphones, tablet computers, digital music players and the like, have been developed that include desirable functionality and thus the number of mobile device users and/or owners keeps growing. Such mobile devices can store all types of information, and can perform many different types of functions for users. The overall popularity of such mobile devices, especially smartphones, has led to the development of processes for using them to conduct financial transactions, for example, transmission of a payment between a payer (a consumer, accountholder, payment card account holder or cardholder) and a recipient (or payee, such as a merchant or another cardholder).

A significant concern of payment systems is the protection of primary account numbers (PANs) (typically a sixteen-digit number) associated with financial accounts of consumers and of merchants from access by vandals or other wrongdoers. Thus, an important initiative for preventing the unauthorized access to PANs involves the use of “tokenization,” to transform a PAN into a token for use in the payment process. Thus, tokens have been defined as “surrogate/alternate values that replace PANs” in part of a payment system. For example, a typical consumer credit card includes the cardholder's name, a sixteen-digit personal account number (PAN), an expiration date and a security code, and any or all of this data can be “tokenized.” Tokenized data typically includes, but is not limited to, a token PAN, session keys or cryptographic keys that can be used a single time, or for a limited time, during a transaction. Once the tokenized card credentials are delivered into the consumer's device or wallet, the consumer can then use them to make a tokenized transaction with a merchant. Typically, the consumer taps a contactless merchant terminal with his or her mobile device that has a mobile payment application containing tokenized credentials to make an in-store NFC transaction. Another example for in-store digital payments with tokenized credentials includes those with barcodes (e.g., Quick-Response (QR) codes), where either the consumer scans a merchant generated QR code, or the merchant scans a consumer generated barcode/QR code. A consumer could also make an online transaction (e.g., using a mobile payment application or a web wallet) using tokenized credentials. The token PAN, which typically has the same format as the PAN and is associated with the cardholder's sixteen-digit account number, is used to complete the purchase. The token is generated and managed, e.g., by a token service provider (TSP), issuer, issuer processor, trusted service manager (TSM), and/or wallet service provider (WSP) (wherein the TSP, WSP, TSM, and issuer may be of the same entity or may be separate entities) which also de-tokenizes the token to obtain the PAN for use in processing the purchase transaction. Such processing improves the payment security of the transaction, since only the TSP/TSM/WSP, payment network and Issuer/Issuer processor see the actual PAN; the merchant and acquirer only see the token PAN.

With regard to payment card account transactions, it is also known to perform velocity checks in order to prevent fraud. A common trait of Card Not Present (CNP) fraud is a fraudster or thief using a stolen payment card account number to conduct one fraudulent transaction to see if the payment card will work, and then quickly maxing out the credit limit of that payment card account (if the first transaction was accepted) by engaging in multiple subsequent transactions in a short period of time. Such fraud can result in chargebacks and lost revenue for issuer financial institutions and/or for merchants. Thus, velocity checks entail monitoring the number of times a specific data element occurs within a specified interval. Typical data elements used for velocity checks of a transaction include, but are not limited to, the User ID, CVM information, the IP address, e-mail address, phone number, device ID and/or device signature, digital wallet application ID, account (e.g., credit, debit, prepaid card) number and/or payment method, billing address, and shipping address. In some implementations, a velocity check is made up of three or more variables, but typically always includes the quantity, data element, and timeframe of a transaction or transactions. Examples of velocity checks include:
How many transactions has a customer completed in the last 24 hours?
How much has a customer spent in the last 24 hours?
Has the consumer been authenticated? What type of CVM has been used?
How many transactions have originated from a single device in the last 24 hours?
How many orders have been placed with the same credit card number, but differing shipping addresses in the last 24 hours?
How many transactions have originated from one IP address, digital wallet or device in the last 24 hours?
How many billing zip codes has a customer loyalty card been used in within the last 30 days?

Therefore, if certain or specified customer data is entered into a payment network/gateway multiple times within a designated time period, the payment network/gateway may take several actions to prevent fraud. For example, the payment network/gateway may reject one or more of the purchase transaction(s), notify the cardholder of the transaction(s) to seek confirmation or repudiation, and/or notify the merchant.

Velocity checks may be performed locally on the consumer device, and/or with the token service provider (TSP/TSM, etc.) backend systems, and/or with the issuer backend systems utilizing on-consumer-device CVM (CDCVM) information. For example, information regarding cardholder verification method (CVM) entry, and whether successfully performed, could be provided within the cryptogram that is generated (either by the consumer device or by the wallet server) at the time of authorization. This information could then be utilized during the authorization transaction in order to decide whether to continue processing of the transaction or to decline it. Velocity check parameters are typically configured by the issuer and/or by the wallet service provider. The consumer may, for example, be requested to provide CVM after three low value transactions (LVTs) and a CVM for every high value transaction (HVT). If the CVM information is not entered, or is entered incorrectly, the TSP or issuer may decline the transaction and/or suspend the consumer's wallet account. It should be understood that the trusted service provider can be the entity that also may be acting as any one, or all of the following: the TSP, wallet service provider, SRC system, issuer and MNO.

Processes are also known wherein a payer or consumer utilizes a mobile device by using its contactless interface, such as a Near Field Communication (NFC)/Host Card Emulation (HCE) controller, at a merchant store to initiate a purchase transaction. Secure contactless transactions can be conducted using tokenized digital credentials stored within the mobile device. The consumer utilizes a mobile payment application to generate an application cryptogram and transmits it using the contactless interface of his or her mobile device to the merchant's Point-of-Sale (POS) terminal. The transaction is then sent to the payments processing network, which may include an acquirer, payment network, token service provider, and issuer. (It is contemplated that future systems and/or processes will support different CVM models as applicable to QR code payments, and/or DSRP/online payments, and the like.)

Mastercard International Incorporated, the assignee of the present application, has developed the “Mastercard Digital Enablement Service” (MDES) platform, which provides a suite of on-behalf-of (OBO) services that support the management, generation, provisioning and utilization of digital payment credentials (such as tokens) into and/or using mobile devices and/or wallet servers. For example, the MDES platform generates and manages tokens, and can provide an EMV-like version of the merchant's account number. (“EMV” stands for Europay, Mastercard, Visa, and denotes a global standard for chip-based debit card account and credit card account transactions that ensures security and global acceptance of such accounts.) Thus, a user of the MDES platform may engage in digital transactions that include cryptograms, dynamic data and the like for added security.

A digital wallet system or SRC system can work together with a TSP/issuer platform to enable the tokenization and digitization of payment cards into digital payment applications and/or wallets or online payments on a merchant web site or application. In addition, an issuer financial institution (FI) can implement a cloud-based payment compliant system, such as Mastercard Cloud-Based Payments (MCBP), to enable secure cloud-based contactless payments and in-app payments (with or without the MDES as a trusted service provider); in some implementations, the issuer or a third party may act as an MCBP TSP independent of the MDES). The implementation of TSP application programming interfaces (APIs), and if applicable, other issuer/wallet service provider and/or payment acceptance connectors may be used enabling a digital wallet or merchant accepting SRC payments to connect to the digital wallet acceptance network or SRC system.

Each cardholder verification method (CVM) model has a different personalization profile, and thus requires different configurations both at the wallet and token service provider levels. In addition, each user experience (UX) may require a different implementation with a token service provider, which would make it difficult to support multiple CVM models within a single digital wallet solution. As a result, supporting multiple CVM models requires use of multiple token service provider (TSP) projects and wallet implementations, incurring high implementation, operational and maintenance costs, while also increasing time-to-market and complexity for issuers and/or wallet service providers. Additionally, it is not possible for an issuer/wallet service provider to alter the selected CVM model without affecting previous consumers once the wallet implementation has been developed. If a CVM model is changed, transactions of previous wallet users may then be declined if those wallet users do not upgrade to the new supported CVM model.

In the current retail environment, consumers want to be able to make digital payments using their mobile devices at their own convenience, and merchants wish to increase their footprint in the marketplace by accepting digital payments. However, each market and/or region has different security and/or consumer experience needs. In addition, some consumer devices cannot support certain CVM models due to limited device capabilities. Moreover, a consumer may not want to utilize a certain CVM method due to security concerns or usability issues, for example, a consumer may not want to enable usage of biometrics, or may find it tedious to have to unlock the mobile device to make a payment, especially for a transit payment at a subway. Additionally, some CVM models are currently not supported in certain channels such as e-commerce. Specifically, the industry is moving away from static passwords (as described in the PSD2, FIDO Alliance, W3C and SRC frameworks) and instead requiring strong consumer authentication, and moving towards a risk based authentication model for a better user experience, wherein CVM is only requested from the consumer if there is a medium or higher risk involved for the transaction. Therefore, there is a need to support additional CVM and/or authentication methods for e-commerce, e.g. a CVM model that will allow the consumer to provide a CVM for medium and/or higher risk transactions, and not require a CVM for low risk transactions.

Therefore, a need exists for methods and systems that enable multiple and/or flexible CVM models for a single mobile device, digital wallet solution, or SRC system, so that consumers can select, including via on-the-fly CVM selection, a CVM method that best suits his or her needs for any channel (in-store, online, or in app). In addition, such methods and systems must provide a seamless user experience (UX) to consumers, while at the same time providing an end-to-end, low cost and quick time-to-market solution for issuers and/or wallet service providers.

### Glossary of Terms

A “payment network” is a system or network used for the transfer of money via the use of cash-substitutes, which may be for thousands, millions, and even billions of transactions during a given period. Payment networks may use a variety of different protocols and procedures in order to process the transfer of money for various types of transactions. Transactions that may be performed via a payment network may include product or service purchases, credit purchases, debit transactions, fund transfers, account withdrawals, and the like. Payment networks may be configured to perform transactions via cash-substitutes, which may include payment cards, letters of credit, checks, transaction accounts, and the like means. Payment networks may also provide value-added services related to payment transactions, including operation as a token service provider for the use of tokenized payment credentials. Examples of networks or systems configured to perform as payment networks include those operated by MasterCard®, VISA®, Discover®, American Express®, PayPal®, and the like. Use of the term “payment network” herein may refer to both the payment network as an entity, and the physical payment network and/or components, such as the equipment, hardware, middleware and/or software comprising the payment network.

A “transaction account” or “payment account” is a financial account that may be used to fund a transaction, such as a checking account, savings account, credit account, virtual payment account, Blockchain account, and the like. A transaction account may be associated with a consumer or user, which may be any suitable type of entity associated with a payment account, which may include a person, family, company, corporation, governmental entity, and the like. In some instances, a transaction account may be virtual, such as those accounts operated by Mastercard®, PayPal®, and the like.

An “issuer” or “issuer financial institution (FI)” is an entity that establishes (e.g., opens) a letter or line of credit in favor of a beneficiary, and honors drafts drawn by the beneficiary against the amount specified in the letter or line of credit. In many instances, the issuer may be a bank or other financial institution (FI) authorized to open lines of credit. In some instances, any entity that may extend a line of credit to a beneficiary may be considered an issuer or issuer FI. The line of credit opened by the issuer FI may be represented in the form of a payment account, and may be drawn on by the beneficiary via the use of a payment card. An issuer may also offer additional types of payment accounts to consumers as will be apparent to persons having skill in the relevant art, such as debit accounts, prepaid accounts, electronic wallet accounts, savings accounts, checking accounts, and the like, and may provide consumers with physical means or non-physical means for accessing and/or utilizing such an account, such as debit cards, prepaid cards, automated teller machine cards, electronic wallets, checks, etc.

A “merchant” is an entity that provides products (e.g., goods and/or services) for purchase by another entity, such as a consumer or another merchant. A merchant may be a consumer, a retailer, a wholesaler, a manufacturer, or any other type of entity that may provide products for purchase as will be apparent to persons having skill in the relevant art. In some instances, a merchant may have special knowledge in the goods and/or services provided for purchase. In other instances, a merchant may not have or require any special knowledge in offered products. In some embodiments, an entity involved in a single transaction may be considered a merchant. In some instances, as used herein, the term “merchant” may refer to an apparatus or device of a merchant entity. Also, as used herein, a “merchant server” may refer to computing systems or network of computers and/or other infrastructure configured to perform the functions of a merchant or operate in the assistance thereof.

A “Point-of-Sale (POS)” is a computing device or computing system configured to receive interaction with a user (e.g., a consumer, employee, etc.) to obtain transaction data, payment data, and/or other suitable types of data for the purchase of and/or payment for goods and/or services. The POS may be a physical device (e.g., an electronic terminal, a cash register, a kiosk, a desktop computer, a smartphone, a tablet computer, and the like) in a physical location that a customer visits as part of the transaction, such as in a “brick and mortar” store, or may be in a virtual e-commerce (online payment) environment, such as online retailers receiving communications from customers over a network such as the Internet where the point-of-sale may be considered to be a merchant website. In instances where the point-of-sale may be virtual, the computing device operated by the user to initiate the transaction or the computing system that receives data as a result of the transaction may be considered the point-of-sale, as applicable.

“Payment rails” are the infrastructure associated with a payment network used in the processing of payment transactions and in the communication of transaction messages and other similar data between the payment network and other entities interconnected with the payment network, which handles thousands, millions, and even billions of transactions during a given period. The payment rails may include the hardware used to establish the payment network and the interconnections between the payment network and other associated entities, such as financial institutions (FIs), gateway processors, etc. In some instances, payment rails may also be affected by software, such as via special programming of the communication hardware and/or devices that comprise the payment rails. For example, the payment rails may include specifically configured computing devices (i.e., routers) that are specially configured for the routing of transaction messages, which may consist of specially formatted data messages that are electronically transmitted via the payment rails, as discussed in more detail below.

Secure Remote Commerce (SRC) is an evolution of remote commerce that provides for secure and interoperable card acceptance established through a standard technical framework and specification, which is promulgated by EMVCo, LLC. SRC enables a merchant (or its agent) to securely request and receive interoperable payment data used to process accepted cards in a remote commerce transaction. Thus, SRC is a common approach that provides security and interoperability to deliver a safe card payment experience in a remote environment. SRC aims to enable the secure exchange of payment information through common interfaces between participating entities, which may include, for example, merchants and issuers. EMVCo published a technical framework which provides guidance for participation in an SRC Program, and a specification which provides requirements for stakeholders who actively interact with an SRC System. The technical framework is the foundation which includes broad SRC concepts and payment ecosystem considerations for the establishment of an SRC Program, and it includes roles and functions for stakeholders who participate in an SRC Program. The specification is an extension of the technical framework, which provides requirements for the SRC ecosystem. The specification also includes requirements and data definitions for specific use cases, and can be found at www.emvco.com/emv-technologies/src/. An SRC system may work with, or comprise, or be comprised by, a TSP (such as MDES).

A “Consumer Device Cardholder Verification Method” (CDCVM) is a type of Cardholder Verification Method where the cardholder uses his or her mobile device to verify his or her identity for a transaction. Most Mobile Payment Apps (MPAs) support a CDCVM.

The “Mastercard Digital Enablement Service” (MDES) supports the following types of Consumer Device Cardholder Verification Methods (CDCVMs):
1. Mobile PIN: A personal identification number (PIN) that the cardholder enters on his or her mobile device and that is validated online by the MDES during the authorization process.
Mobile PIN is supported with MCBP 1.0 and MCBP 2.0. The Mobile PIN value may be specific to a particular token in the Mobile Payment App (“Token-specific” Mobile PIN), or may be the same for all tokens within the same Mobile Payment App instance (“Wallet-level”) Mobile PIN.
2. Locally-verified CDCVM is a CDCVM entered on, and validated by, the consumer's device. For example, a locally-verified CDCVM may be a device PIN, pattern, password or biometric methods (such as a fingerprint data, iris scan data, and/or facial recognition data). These methods are commonly associated with a device unlock process and are validated on, for example, the cardholder's mobile device. Thus, in some implementations, the payment component embedded in the Mobile Payment Application (MPA) will use the outcome of this authentication process.
Locally-verified CDCVM is supported from MCBP version 2.0. A locally-verified CDCVM applies to all the tokens of a given Mobile Payment App instance (“Wallet-level”). With locally-verified CDCVM, MDES or the wallet does not need to store any CDCVM credential.

### BRIEF DESCRIPTION OF THE DRAWINGS

Features and advantages of some embodiments of the present disclosure, and the way such embodiments are accomplished, will become more readily apparent upon consideration of the following detailed description taken in conjunction with the accompanying drawings, which illustrate exemplary implementations and are not necessarily drawn to scale, wherein:

FIG. 1 is a block diagram of a consumer mobile device to illustrate device hardware components that may be utilized in accordance with methods and systems disclosed herein;

FIG. 2 is a system block diagram illustrating a tokenization system with multi-CVM support in accordance with the present disclosure;

FIG. 3 illustrates system components of another embodiment of a tokenization system with multi-CVM support in accordance with the present disclosure;

FIG. 4A is a flow diagram illustrating an in-store, low value transaction (LVT), contactless payment transaction process with a default CVM model according to some embodiments of the disclosure;

FIG. 4B is a flow diagram 450 illustrating an in-store, high value transaction (HVT), contactless payment transaction process with a default CVM model according to some embodiments of the disclosure;

FIG. 5A is a flow diagram illustrating an in-store, low value transaction (LVT), contactless payment transaction process with on-the-fly CVM model selection by the user according to some embodiments of the disclosure;

FIG. 5B is a flow diagram illustrating an in-store, high value transaction (HVT), contactless payment transaction process with on-the-fly CVM model selection by the user according to some embodiments of the disclosure;

FIGS. 6A-6D illustrate examples of screen displays (or screen shots) of mobile device user interface screens to illustrate a mobile device contactless transaction user experience in accordance with some embodiments of the disclosure;

FIGS. 7A-7C are examples of screen displays (or screen shots) of two different contactless transaction user experiences that can occur when the mobile device is locked, in accordance with some embodiments of the disclosure;

FIGS. 8A-8H illustrate examples of screen displays (or screen shots) of mobile device user interface screens to illustrate an in-store QR code transaction user experience in accordance with some embodiments of the disclosure;

FIGS. 9A-9C illustrate examples of screen displays (or screen shots) of mobile device user interface screens associated with a digital secure remote payment (DSRP) or secure remote commerce (SRC) payment transaction user experience in accordance with some embodiments of the disclosure;

FIG. 10A is a flow diagram illustrating a wallet registration process with digital by default provisioning, and with CVM model selection by the issuer or service provider, according to some embodiments of the disclosure;

FIG. 10B is a flow diagram illustrating an add payment account by accountholder process with non-digital by default provisioning, and with no CVM model selection by the cardholder according to some embodiments of the disclosure;

FIG. 10C is a flow diagram illustrating an add payment account and select CVM by cardholder process with non-digital by default provisioning according to some embodiments of the disclosure;

FIG. 10D is a flow diagram illustrating an add payment account process with non-digital by default flow with CVM model selection by the issuer or service provider according to some embodiments of the disclosure; and

FIG. 10E is a flow diagram illustrating an add payment account for web wallet or SRC accountholder process with non-digital by default provisioning, and with no CVM model selection by the cardholder according to some embodiments of the disclosure.

### DETAILED DESCRIPTION

Reference will now be made in detail to various novel embodiments, examples of which are illustrated in the accompanying drawings. It should be understood that the drawings and descriptions thereof are not intended to limit the invention to any particular embodiment(s). On the contrary, the descriptions provided herein are intended to cover alternatives, modifications, and equivalents thereof. In the following description, numerous specific details are set forth in order to provide a thorough understanding of the various embodiments, but some or all of these embodiments may be practiced without some or all of the specific details. In other instances, well-known process operations have not been described in detail in order not to unnecessarily obscure novel aspects.

A number of terms will be used herein. The use of such terms is not intended to be limiting, but rather are used for convenience and ease of exposition. For example, as used herein, the term “user” may be used interchangeably with the term “consumer,” “cardholder” and/or “accountholder,” and are used herein to refer to a consumer, person, individual, business or other entity that owns (or is authorized to use) a financial account such as a payment account (for example, a credit card account). In addition, the term “payment account” may include a credit card account, a debit card account, a prepaid card, and/or a deposit account or other type of financial account (for example, a Blockchain account) that an account holder may access. The term “payment account number” includes a number that identifies a payment account or a number carried by a payment card, and/or a number that is used to route a transaction in a payment system that handles debit card and/or credit card transactions and the like. In addition, the term “mobile payment application” (MPA) may be used interchangeably herein with the term “mobile wallet application.” Additionally, the term “wallet” is used herein interchangeably with the term “digital wallet”, wherein “wallet” may refer to the client (front-end) side or may refer to the entirety of the wallet solution, including the back-end system(s). In addition, the term “DES” pertains to a Digital Enablement Service which functions as a trusted service provider, and which provisions digital payment credentials (such as tokens) into and/or using mobile devices and/or wallet servers. The DES may be a token service provider, or a trusted service provider, and/or a wallet service provider. For example, the DES can be the MDES platform, provided by Mastercard International Incorporated, the assignee of the present disclosure.

In general, and for the purposes of introducing concepts of novel embodiments described herein, systems and processes are disclosed that provide a tokenization system with multiple-cardholder verification method (multi-CVM) support for securely performing in-store purchase transactions, and online purchase transactions (such as contactless chip card, magnetic stripe (or magstripe), Digital Secure Remote Payment (DSRP), or Secure Remote Commerce (SRC) wherein DSRP and SRC encompass online tokenized transactions), with on-the-fly CVM selection support. In some embodiments, cryptograms are generated for EMV-like secure digital payments utilizing tokenized digital credentials. Usage of dynamic cryptograms that incorporate a channel indicator (i.e., point of sale (POS) and/or eCommerce), a random number (nonce) and cardholder verification data prevents replay attacks, cloning attacks and cross channel attacks. Thus, the processes disclosed herein advantageously prevent an attacker or thief from using the same cryptogram a second time, or on a different channel, or on a different device.

In practical systems in accordance with embodiments described herein, multiple merchants and/or multiple issuers are operably connected to the tokenization system that supports multiple CVM. In some embodiments, only registered merchants can accept payments, which mitigates or eliminates the redirection of funds to fraudulent merchants, beneficially reduces money-laundering scams, and minimizes the loss of money by consumers. In addition, only those consumers who authenticate themselves against an issuer financial institution (FI) or a trusted third party have access to a digital wallet, which eliminates unauthorized access to consumer accounts. Thus, the disclosed solution is valid for any kind of mobile device and/or digital wallet, banking application or the like that supports tokenized transactions using the disclosed tokenization system, including an issuer FI, wallet service provider wallets (such as Apple Pay, and the like), and scheme-operated EMVCo compliant or other digital wallets, including SRC, Masterpass™ (Mastercard digital wallet platform). In addition, in some embodiments, the disclosed techniques require consumers to consent to a payment transaction by confirming the transaction amount and requiring entry of a customer verification method (CVM) for a card present transaction. Requiring the consumer to provide consent prevents a merchant from withdrawing an amount the consumer has not approved of, thereby reducing chargebacks.

In accordance with disclosed embodiments, application cryptograms (including mobile device (MD) cryptograms and user-mobile device (UMD) cryptograms) are generated and used for smart card (or chip card, such as M/Chip™ card) transactions, for magnetic stripe (Magstripe or contactless mag stripe) payment card transactions, for Digital Secure Remote Payment (DSRP) transactions or SRC transactions (such as online transactions occurring over the Internet utilizing a cloud-based system) with a mobile device. For example, a cryptogram may be generated either by a mobile payment application for contactless chip card transactions or device based SRC/DSRP transactions using tokenized credentials, or may be generated in the cloud for SRC/DSRP transactions on legacy systems.

In some embodiments, transactions are initiated by a consumer, by using his or her device to make contactless chip card (i.e., M/Chip), contactless magstripe, or online (DSRP or SRC) payments. In additional to mobile device hardware, software components such as a mobile wallet application, web page and/or a web wallet may also be utilized to conduct the transaction. A cryptogram generated by the consumer's mobile device is sent to the merchant's POS terminal, for example, by using NFC communications (or by use of a scanner to scan a barcode, or other wireless communications technology, such as Bluetooth, magnetic induction, etc. or via the Internet). In some implementations, the consumer is then prompted to enter data to satisfy a cardholder verification method (CVM) before completing the transaction, by using one or more components associated with his or her mobile device. For example, the consumer may enter a mobile personal identification number (mobile PIN), or log into a wallet application, or authenticate themselves against the device (device level authentication), which may include using components such as a touch screen and/or a digital camera and/or a fingerprint scanner to provide biometric data, such as a fingerprint, a pattern, a device passcode, or the like. If all is in order, then processing proceeds to complete the transaction.

In some other disclosed embodiments, a consumer may initiate the transaction on a merchant website or wallet application (which is integrated with the merchant systems and/or acceptance network) at a point-of-interaction (POI). The POI may be, for example, a point-of-sale (POS) terminal or a merchant's mobile device. In such implementations, the consumer may receive a notification to complete the transaction on his/her device, and then the consumer is prompted to enter authentication data to satisfy a CVM (for example, by entering a mobile personal identification number (mobile PIN), by logging into a mobile payment application, or by authenticating themselves against the device (device level authentication or DLA), including screen unlock, or providing biometric data) using one or more consumer mobile device components (such as a touch screen and/or a digital camera and/or a fingerprint scanner). If all is in order, then processing may proceed in a known manner to complete the transaction.

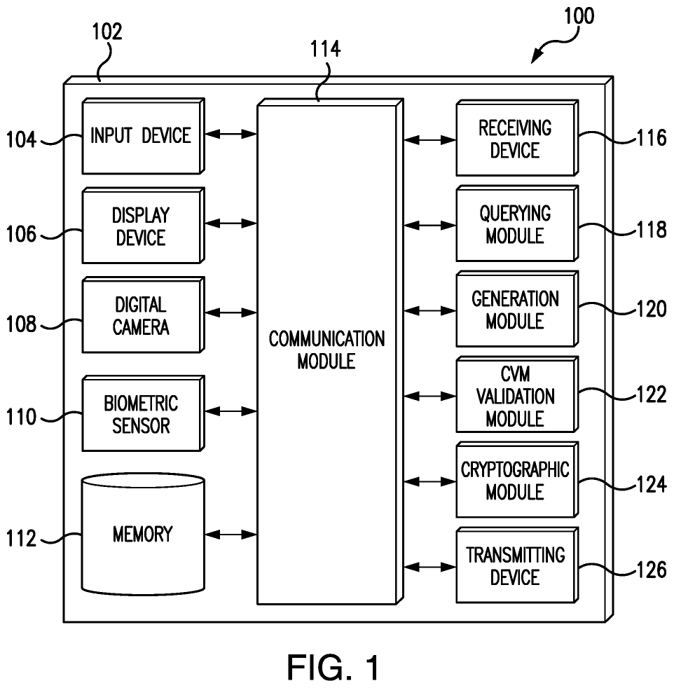

FIG. 1 is a block diagram 100 of a consumer mobile device 102 to illustrate device hardware components that may be utilized to perform transactions in accordance with methods and systems disclosed herein. Currently, many users habitually carry with them mobile devices 102, such as smartphones, tablet computers, wearables or the like, which are configured for entering into mobile payment transactions. The consumer's mobile device 102 (such as an iPhone™ or Android™ device) typically includes hardware components such as a microphone and a speaker (not shown), an input device 104 (which may be a touchscreen), a display device 106, a digital camera 108, and a memory 112. Some mobile devices 102 also include a biometric sensor, such as a biometric sensor 110 (for example, a fingerprint sensor, an iris sensor, or other type of biometric sensor). The consumer's mobile device 102 also includes a communication module 114 (which may include one or more microprocessors) operably connected to the input device 104, the display device 106, the digital camera 108, the biometric sensor 110, and the memory 112. In addition, the communication module 114 is operably connected to a receiving device 116, a querying module 118, a generation module 120, a CVM validation module 122, a cryptographic module 124 (for any cryptographic operation needed in the device, including encryption and decryption operations, for example, for generating device cryptograms, for securely storing and/or retrieving data in and/or from the memory 112, or for secure communications via the receiving device 116 and transmitting device 126), and a transmitting device 126. In some embodiments, the CVM validation module 122 may contain one or more of a CVM risk management submodule, a transaction credentials management submodule, a wallet CVM management submodule, a consent management submodule, and a cryptogram validity submodule (not shown). The communication module 114 operates to provide a seamless digital payment transaction user experience (UX) to a consumer in a manner that also allows the consumer to make an on-the-fly CVM selection during a transaction that best suits his or her needs, as explained below.

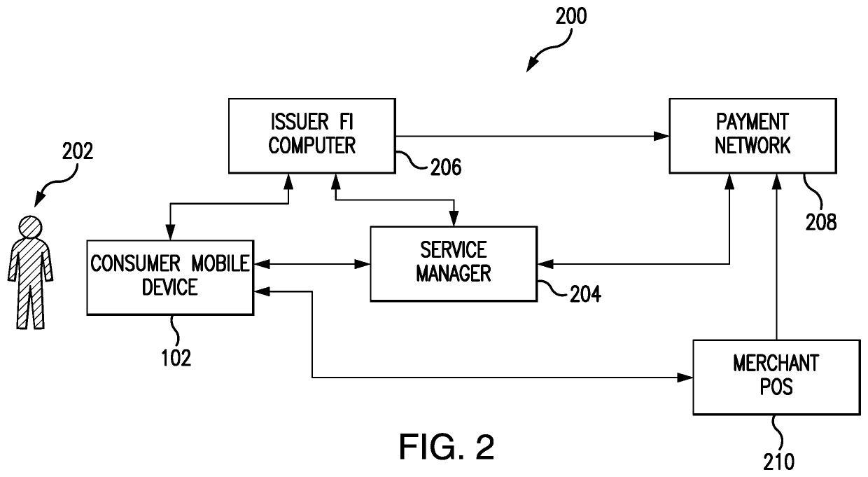

FIG. 2 is a block diagram illustrating a tokenization system 200 with multi-CVM support in accordance with some embodiments of the disclosure. A service provider computer 204 is operably connected to an issuer financial institution (FI) computer 206, a payment network 208, and a consumer mobile device 102 of a consumer 202. The consumer 202 may utilize the mobile device 102 to conduct a purchase transaction with a merchant POS 210 (which may be, for example, a POS terminal, a merchant mobile device, or a merchant website), which is also operably connected to the payment network 208 (either directly or via an acquirer). For example, the consumer utilizes the mobile device 102 to conduct a transaction with the merchant POS 210. In accordance with some embodiments, the consumer 202 uses an input device 104 (See FIG. 1) to select a payment account from, for example, a digital wallet, mobile banking application, online banking website, or SRC supported/accepted merchant web site, to select a CVM model (or to change a default CVM model defined for the transaction), and to choose to “Pay,” which may be selected from a menu or User Interface (UI) (not shown) presented on the display screen 106. In embodiments disclosed herein, the consumer has multiple payment options such as to “tap & pay” (pay with NFC), pay with QR code, and the like. If, for example, the consumer selects to pay with QR code, the mobile device generation module (or mobile wallet application/web wallet application/SRC supported website) then generates a QR code which is displayed on the consumer device display screen 106. The merchant then uses a camera component or scanner (not shown) of a merchant POS 210 to scan the consumer generated QR code which is displayed on the display screen 106 of the consumer device 102. The merchant POS 210 then parses the QR code, which contains consumer payment account information, and transmits a payment authorization request including the transaction amount to the payment network 208 for processing.

In another example, the consumer selects to “Pay with NFC,” and in this case payment account information, a count-down timer, and instructions to tap the consumer mobile device 102 on a reader device (not shown, which is associated with the merchant POS 210) may be displayed on the display screen 106 of the consumer's mobile device 102. The consumer may then be instructed to tap the reader device with the mobile device 102 and next provide authentication data before a predetermined time period shown by the count-down timer expires. If authentication was not performed within the predetermined period of time (i.e., the time shown on the count-down timer expires) before selecting to pay, then the process would need to be restarted (the transaction would not be completed).

In accordance with methods disclosed herein, when the consumer confirms or consents to providing payment for the purchase transaction (and, in some cases, provides CVM data), tokenized smart card data (or Magstripe data, which may be used as a fallback process) is generated by the consumer's mobile wallet application. In some embodiments, a Mobile Device (MD) cryptogram and a User Mobile Device (UMD) cryptogram are both generated by the generation module 120 and/or cryptographic module 124 of the mobile device and/or mobile wallet application in accordance with existing Mastercard Cloud Based Payments (MCBP) specifications (and thus such cryptograms may also be valid for future releases of the MCBP specification, or updated to comply with such future releases). Next, purchase transaction authorization occurs by using “business as usual” (BAU) transaction processing of tokenized data, which can include utilizing an acquirer FI computer (not shown), the payment network 208, the service provider 204 (which may be a token service provider, such as the MDES), and the issuer FI computer 206.

Referring again to FIG. 2, to conduct an online transaction, e.g., a digital secure remote payment (DSRP) or SRC transaction, the user 202 may utilize a mobile wallet application or a web wallet application resident on the mobile device 102. Alternatively, the user may perform an online transaction via the Internet (not shown) without using a wallet, and could conduct the transaction, e.g. on a merchant website (not shown) supporting SRC payments. The consumer may be provided with an option to change the default authentication mechanism/CVM defined for the transaction. Next, the user may be requested to complete the transaction by entering a CVM (i.e., a mobile PIN, biometric data, OTP code and the like) using the biometrics sensor 110 and/or input device 104 and display device 106 to verify the purchase transaction. In this example, a Digital Secure Remote Payment (DSRP)/SRC device token is then generated by the mobile device's generation module and/or cryptographic module 124 (and/or mobile payment application, if supported by the mobile device), or a DSRP/SRC cloud token is retrieved from the service provider 204 (which may include a wallet server). Next, purchase transaction authorization occurs by using “business as usual” (BAU) processing of the data.

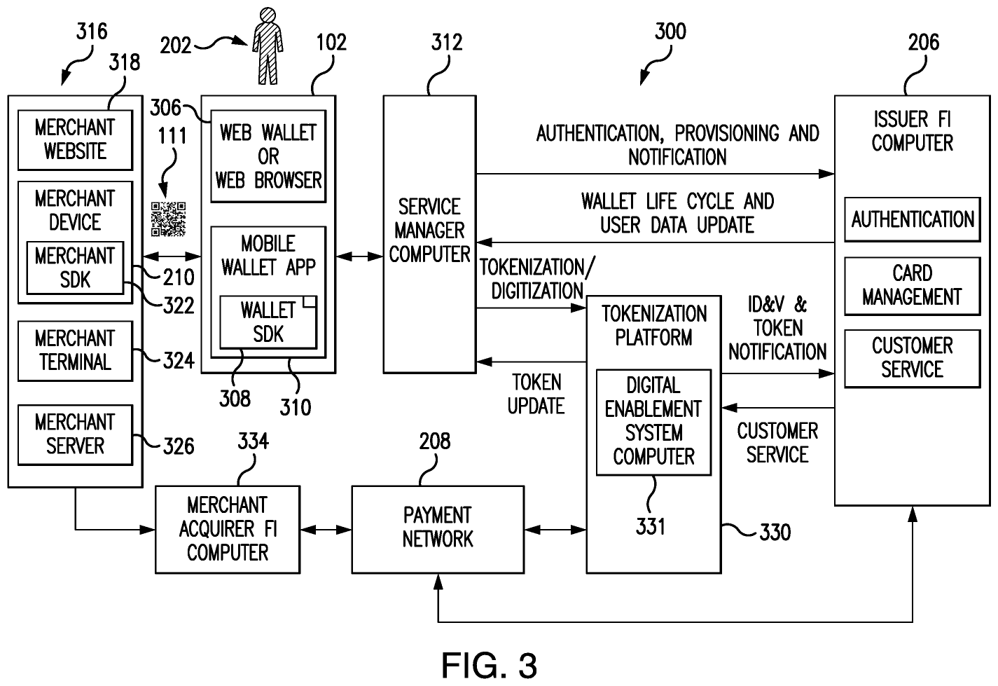

FIG. 3 illustrates another embodiment of a tokenization system 300 with multi-CVM support in accordance with the present disclosure. An individual user and/or cardholder or consumer 202 utilizes a consumer mobile device 102 that may include software components, as mentioned above, for facilitating purchase transactions. In some implementations, the consumer mobile device includes and/or utilizes a web browser and/or a web wallet application 306 and/or a mobile wallet application 308, which may include a wallet software development kit (SDK) 310. The querying module 118, receiving module 116 and transmitting module 126 (see FIG. 1) of the mobile device 102 may be used to facilitate communications between the digital wallet and a wallet service provider and/or issuer FI and/or token service provider, as well as for payment card, transaction, fraud and digital wallet management functions, and the like. Data received using the receiving module 116 or sent using the transmitting module 126 of the mobile device could be securely stored or retrieved in/from the memory module 112 using the cryptographic module 124 and/or CVM validation module 122 of the mobile device. The CVM validation module 122 of the mobile device is used in performing authentication (performing/managing/validating CVM on the device). The mobile device's hardware and/or software (e.g. wallet SDK) may utilize the aforementioned modules, or the hardware modules within the device may utilize software for performing such functions.

In some implementations, a generation module 120 and/or a cryptographic module 124 (see FIG. 1) of the mobile device 102 generates a cryptogram for use in purchase transactions. In another embodiment, the mobile device includes software instructions (such as a mobile wallet application 308) configured to generate a cryptogram for use in purchase transactions. In an embodiment, the generation module or mobile wallet application 308 within the consumer mobile device 102 is configured to make NFC/HCE transactions using an NFC controller (not shown) of the mobile device, which involves the consumer tapping the mobile device on a contactless POS terminal (not shown) of a merchant to conduct a purchase transaction. In one embodiment, the generation module and/or cryptographic module within the mobile device 102 may be configured for generating a digital barcode 111 (which may be a QR code) during a purchase transaction that can be displayed on a display screen or display device 106 (See FIG. 1 for reading by a camera component or a barcode scanner (not shown) associated with the merchant POS 210. It should be noted that NFC and barcode payments are non-limiting examples of in-store payments, and thus other wireless communications technologies such as Bluetooth, WiFi, RFID, magnetic induction, and the like could also be utilized for in-store payments.

In yet another embodiment, the consumer initiates a purchase transaction online from, for example, a merchant website. A merchant terminal 324 (which may be, for example, a POS terminal) then submits the received data as a transaction request, for example, to a merchant server 326 or directly to the merchant acquirer financial institution (FI) computer 334 for forwarding to a payment network 208. The payment network 208 then conducts further transaction processing, which involves the issuer FI computer 206.

Referring again to FIG. 3, the mobile device 102 is configured for communications with a service manager computer 312 (which may be a wallet server or SRC system, and which may be owned and/or operated by an issuer FI, or an entity such as a Trusted Service Manager, Token Service Provider, Wallet Service Provider (WSP), or a payment processing entity such as Mastercard International Incorporated, the assignee of the present application; and wherein the wallet server/SRC system may include the tokenization platform, or may be separate entities). In some implementations, the communications between the user's mobile device 102 and the service manager computer 312 may occur through use of a private network or a public network (such as the Internet), and/or combinations thereof. As shown, the service manager computer 312 is also operable to communicate with an issuer financial institution (FI) computer 206, and a tokenization platform 330. The service manager computer 312 may transmit mobile device provisioning requests for tokenization and/or digitization to the tokenization platform 330, and may also transmit user and/or mobile device authentication requests, wallet and/or card management requests, and/or notification data to the issuer FI computer 206, and may receive responses to such requests. In addition, the issuer FI computer 206 may provide additional data and or information such as wallet life cycle data, card management data, and/or user data updates to the service manager computer 312. The issuer FI computer 206 may also be configured for providing card management services, authentication and/or access to a customer service representative for customer support regarding the customer's wallet. It should be understood that, in a practical tokenization system 300 that supports multiple CVM (multi-CVM), a plurality of issuer FIs and their associated issuer FI computers 206, a plurality of digital enablement system computers 331, a plurality of mobile devices, a plurality of wallet servers/SRC systems, wallets, acquirers, payment networks and a plurality of merchant systems, may be included.

Also shown in the multi-CVM tokenization system 300 of FIG. 3 are merchant components 316 that may include computer systems for providing a merchant website 318, a merchant POS 210 (that may include similar modules as in the mobile device and/or a merchant software development kit (SDK) 322), a merchant terminal 324, and a merchant server computer 326. The merchant terminal 324 may be a point-of-sale (POS) terminal that includes a contactless NFC reader (not shown), and/or a barcode reader or scanner (not shown), and/or an internet and/or phone line connector (not shown). Each of the merchant components 316 may be in communication with one or more other merchant components, and in some embodiments, a plurality of merchant systems 316 are included on the tokenization system 300, and operable for conducting purchase transactions. The cardholder's mobile device 102 may be configured for communications with one or more of the merchant components 316 to conduct a purchase transaction. The user's mobile device 102 may also be configured for communicating with many types of other devices, such as with the mobile devices (not shown) of other consumers or users, for example, for exchanging audio and/or text messages and the like via a mobile network operator (“MNO”) system, internet or the like (not shown in FIG. 1).

Referring again to FIG. 3, the tokenization platform 330 may include or comprise a (plurality of) digital enablement service (DES) computer system(s) 331, which function(s) as a trusted service provider and may include a token vault (not shown). In some implementations, the DES computer system 331 is operably connected to the service manager computer 312, the issuer FI computer 206, and to the payment network 208 (which may be the well-known Banknet® system operated by Mastercard International Incorporated). As mentioned earlier, the payment network 208 is operably connected to the merchant acquirer FI computer 334 and to the issuer FI computer 206, wherein the merchant's acquirer FI computer 334 is associated with the financial institution (the merchant FI) that provides banking services to the merchant. The merchant acquirer FI computer 334 functions to receive and to route payment transaction authorization requests (which can originate from the merchant server 326, merchant terminal 324, merchant POS 210, and/or the merchant website 318) to the payment network 208 for processing.

In some embodiments, the DES computer system 331 is operable to provide a plurality of on-behalf-of (OBO) services, including digitization and tokenization services to requestors. The DES computer system 331 thus can operate to replace a consumer's payment account number (e.g., primary account number (PAN)) with a token, and to place the token into a service manager computer 312 and/or a consumer's mobile device 102, either directly or via a digital merchant website, web wallet environment or via a mobile wallet environment. The DES computer system 331 thus provides tokenization and/or digitization services and/or token updates to the service manager computer 312, and may also provide identification and verification services, customer services and notifications to the issuer FI computer 206. In some implementations, the DES computer system 331 may also provide tokenization, transaction history and notification services to the payment network 208. In addition, as a provider of tokens, the DES computer system 331 may perform such functions as operating and maintaining a token vault (which stores token data, including token requester credentials and/or payment account data associated with the tokens), generating and issuing or provisioning tokens, assuring security and proper controls, and registering token requestors.

In accordance with a Payment Token Interoperability Standard, token requestors may include payment account issuers (which include issuer FIs, such as banks), card-on-file merchants, acquirer FIs, original equipment manufacturer (OEM) device manufacturers, and digital wallet providers. In some embodiments, each token requestor is required to register with the DES computer system 331 before requesting use of the token service, which includes mapping tokens to card numbers during a purchase transaction in a secure manner (for example, by using cryptograms). In some embodiments, during the tokenization process, the DES computer system 331 may be configured to manage data preparation by generating a personalization profiles, where non-limiting examples include EMV (wherein the term “EMV” stands for “Europay, Mastercard, Visa,” and denotes a global standard for chip-based debit card account and credit card account transactions that ensures security and global acceptance of such accounts), such as contactless M/Chip, contactless mag stripe, DSRP, SRC and the like, based on the brand (e.g. Mastercard, Visa, etc.), product type (credit, debit, prepaid, etc.) and (default/selected) CVM model selection of the token account. Typically, only one CVM model is supported for a personalization profile, therefore, in some implementations, multiple CVM support may require generation of multiple personalization profiles. In addition to the personalization data, transaction credentials, including single use keys/session keys, would be created by DES and delivered to the mobile device. The transaction credentials would be utilized at the time of a transaction in generating a cryptogram. After data preparation is completed, the personalized profile data and transaction credentials are delivered to the mobile device. A cryptogram is generated by the mobile device's generation module, cryptographic module, and/or CVM validation module using the personalized data and transaction credentials, or alternatively retrieved from the wallet server at the time of the transaction. In some implementations, the DES computer 331 performs cryptogram validation and de-tokenization before the purchase transaction is authorized by the issuer FI computer 206. Once the issuer authorizes the transaction, a response is transmitted back to the payment network 208, which then performs token mapping and responds back to the acquirer with the tokenized authorization response. The acquirer then sends the response back to the POS terminal 324 to complete the transaction. Thus, the DES computer system 331 enables connected devices to make secure purchases in-store, in-app and/or online (via the Internet).

Regarding FIG. 3, it should be understood that in a practical tokenization system 300 with multi-CVM support, there will be a plurality of issuer FI computers that typically represent banks or other financial institutions that provide banking services to consumers in addition to issuing payment accounts (for example, credit card accounts, debit card accounts, prepaid card accounts, checking accounts, etc.). Such a practical tokenization system will also include a plurality of consumers 202 and their associated mobile devices 102, as well as a plurality of merchants and their associated merchant components 316, and a plurality of merchant acquirer FI computers 334.

In embodiments described herein, in order for a cardholder 202 to conduct tokenized purchase transactions with her mobile device 102, the cardholder 202 may register his or her mobile device and/or digital wallet. In some implementations, no digital wallet is used, instead a web browser or mobile application supporting SRC payments is used, where SRC may need to be enabled by the consumer prior to, or during, a checkout (or the digital wallet or digital application may already be installed on the consumer's mobile device 102 by default). However, in other implementations, the consumer 202 downloads the mobile wallet application to his or her mobile device 102 from an authorized party (such as a mobile application store like the Google Play™ Store, the App Store™, and the like).

In some implementations, when a mobile wallet application is first downloaded and initialized on the consumers' mobile device 102, or e.g. the wallet or SRC payments is enabled within the issuer mobile banking application, or enabled on the issuer online banking web site, or when registering for a web wallet or SRC for the first time, the mobile wallet application or web wallet may prompt the user or cardholder 202 accept “Terms and Conditions” information appearing on the display screen of her mobile device 102, and to provide consumer registration information. Thus, after accepting the terms and conditions, the consumer 202 is provided with a mobile wallet (or web wallet) consumer registration display screen, which includes a request for entry of various types of consumer information. For example, consumer registration information may include data such as the cardholder's name, email address, phone number, billing address, and the like. If a mobile wallet application is to be enabled, the cardholder may also be requested or prompted to provide a mobile PIN (personal identification number) using the input device 104 or display device 106 (see FIG. 1), or to set Device Level Authentication (DLA) that may include usage of biometrics (for example, a fingerprint if the consumer mobile device includes a fingerprint sensor) for wallet login and/or for the purpose of making a digital payment. The mobile PIN could be valid and/or the same for the entire wallet (referred to as a wallet PIN), or wallet instance, SRC enabled device(s) or valid only for a single payment account. In some implementations, the mobile wallet application may have a one PIN for login (mobile application PIN) and a separate, different PIN (mobile PIN) for payments purposes.

In addition, the consumer may be prompted to add a payment method, such as a credit card account or debit card account. The consumer may be requested to provide additional verification (if requested by the issuer/wallet service provider, etc.) to enable the mobile device or digital wallet for payments. Non-limiting examples for additional verification include providing an activation code (provided by the issuer FI to the consumer 202), or providing data in accordance with a strong customer authentication process requiring, for example, two factor authentication, which may be provided to the consumer by the issuer or trusted service provider, or tokenization service provider, or wallet service provider, etc. The activation code could be sent by the issuer or wallet service provider via separate SMS, email, and the like, or the consumer may be requested to provide biometrics (iris scan, fingerprint, face scan, etc.) or call a customer service representative (CSR) to verify that the consumer is the actual cardholder. Alternatively, the payment method and cardholder information may also be provided by the issuer (using digital-by-default provisioning) after the consumer has authenticated himself or herself against the issuer (e.g., using online banking credentials, biometrics, etc.) or wallet service provider, TSP and the like, instead of requesting it from the consumer.

In some embodiments, the consumer is provided with an option to select a default CVM to associated with a specific payment card, or to associate with the wallet, wallet instance or SRC enabled device (in cases where multiple CVM methods are available and the device being registered is able to support those CVM methods). Alternatively, the issuer FI 206 or the service manager computer 312 may provide the CVM list and set a default CVM method that could be valid for all eligible devices or cards, a specific payment account, wallet or wallet instance, and may provide an option for the consumer to change the method after registration is completed. Accordingly, in embodiments where the issuer FI 206 and/or service manager computer 312 have enabled multiple consumer verification method (CVM) models, then all eligible CVM methods (those CVM methods which are supported by the consumer's mobile device) will be available to the consumer, but not during the registration process. Instead, in the case where the service manager computer 312 of the wallet provider or SRC system determines that the consumer's mobile device 102 supports device level authentication (DLA) then all token payment credential provisioning occurs automatically (digital-by-default provisioning), that is the user does not manually add a card or select CVM. The user instead would be able to change the default card and CVM method after registration.

In some embodiments, the consumer registration information, (default) CVM selection and/or CVM list and payment method(s) (i.e., credit card account number, which may be the user's primary account number (PAN) associated with the cardholder's account) is transmitted to the tokenization platform 330 (which may include a DES computer 331) for account enablement processing. Thus, in some implementations, the DES computer 331 prepares provisioning data that is based on the consumer registration information received from either the service provider 204, or the service manager computer 312, and/or the issuer FI computer 206. The DES computer 331 generates the token payment profile(s) by performing tokenization (generation of the token PAN(s) linked to the card PAN(s)) and digitization (preparation and delivery of token card data, including session keys and/or single use keys, mobile session cryptographic keys, etc., for usage with the consumer mobile device 102). Based on the supported CVM model(s) defined for the payment credential(s) to be tokenized, a token payment credential (card, etc.) profiles and transaction credentials per payment credential and CVM model may be generated, which would be provisioned into the consumer's mobile device 102, and/or service provider 204, and/or service manager computer 312. In order to support multiple CVM models for a single payment credential, a single token would be associated with multiple token payment credential profiles.

Referring again to FIG. 3, in some embodiments, the DES computer 331 transmits the token data to the consumer's mobile device 102 for storage in a memory component 112, such as a secure element, trusted execution environment (TEE), or in software for usage for digital payments. The token payment credential data provisioned into software could also be stored more securely using other methods, such as white box cryptography.

The issuer FI computer 206 or a trusted service provider 204 may be provided an option to enable multiple CVM models during onboarding to a token service provider/DES computer 331. In some embodiments, a CVM model may be limited for use with a certain payment account, channel, consumer device, wallet or wallet instance. For example, the issuer FI may have a contactless wallet solution, and could select multiple CVM models applicable to contactless payments that could be set as the same for all payment accounts in a wallet. Alternatively, the issuer FI 206 and/or service manager computer 312 could allow multiple CVM models per payment account and/or payment credential in a wallet 308 or consumer mobile device 102 for any payment channel.

In some embodiments, the issuer FI and/or service provider 204 may be provided with an option to set a default CVM method for all payment accounts, consumer devices, and/or digital wallets. In another embodiment, the issuer FI and/or service provider may have the option to allow the consumer to set the default CVM, and in this case the consumer may be prompted to select the default CVM during the registration process. In addition, the issuer FI and/or wallet service provider may be provided with the option of being able to support all available and/or all selected CVM methods, or of being able to support only one CVM profile at a time within a particular consumer device (i.e., mobile device) and/or digital wallet and/or digital wallet instance. When the issuer FI and/or service provider (wallet service provider/SRC system) is able to support only one CVM profile at a time, then the token account data, including session keys or single use keys, personalization profile, is provisioned into the consumer's device during registration only for that default CVM method.

In some embodiments, the issuer FI and/or service provider has the option to allow the consumer to change the CVM model after registration. When the issuer FI and/or service provider can only support one CVM at a time, and the user changes the default CVM method, then in some implementations the existing token account credentials are removed from the consumer's device and new credentials are provisioned. This process requires the consumer's mobile device to connect to the tokenization platform (such as the DES computer 331) via an Internet connection (or other type of network connection) in order to provision the new token payment credentials that support the new CVM model. In contrast, when multiple CVM profiles are supported within the same digital wallet and/or wallet instance, payment account or consumer device(s), when the consumer changes the default CVM method there is no need to provision new credentials (and thus there is no need for an Internet connectivity or network connectivity) because all available token payment credentials (of each supported CVM model) have already been provisioned into the consumer device at the time of registration. Thus, when multiple CVM profiles are supported within the same digital wallet and/or wallet instance, payment account or consumer device, the consumer is able to change the CVM model on-the-fly (for example, during a transaction) even at the time of payment for a purchase transaction. When the consumer changes the CVM model, the change is then indicated in the CVM validation module of the consumer's mobile device, and thus the appropriate token payment credentials would be utilized for the transaction. In some embodiments, an indication regarding the changed CVM model would also be communicated to the token service provider (DES computer 331) within the application cryptogram generated by the mobile device.

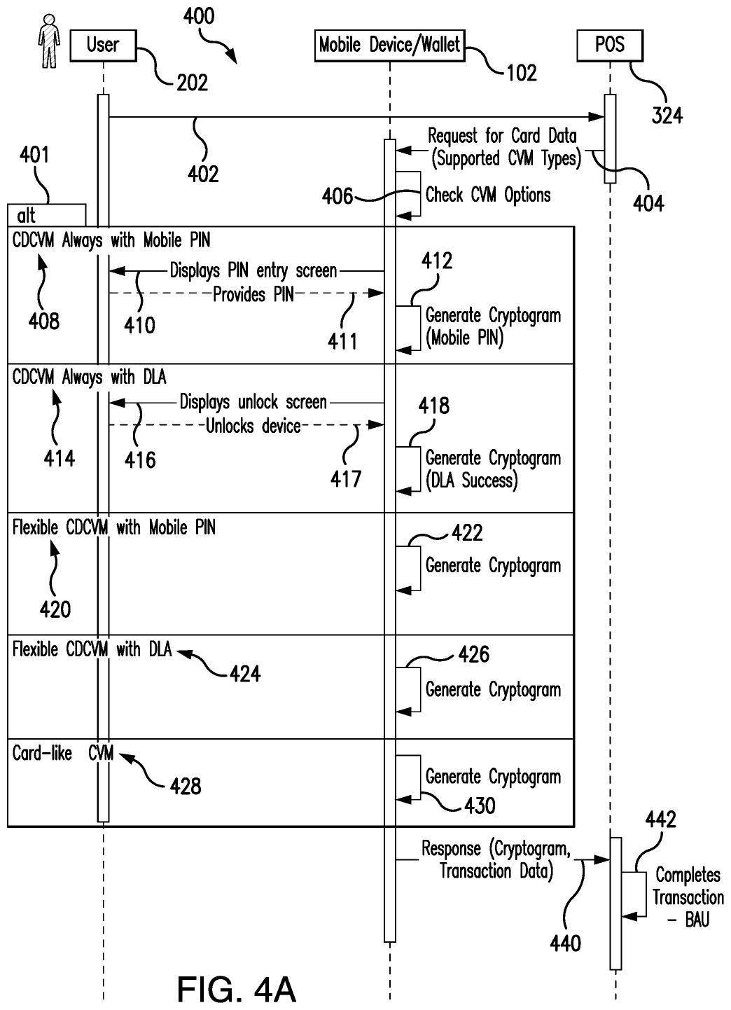

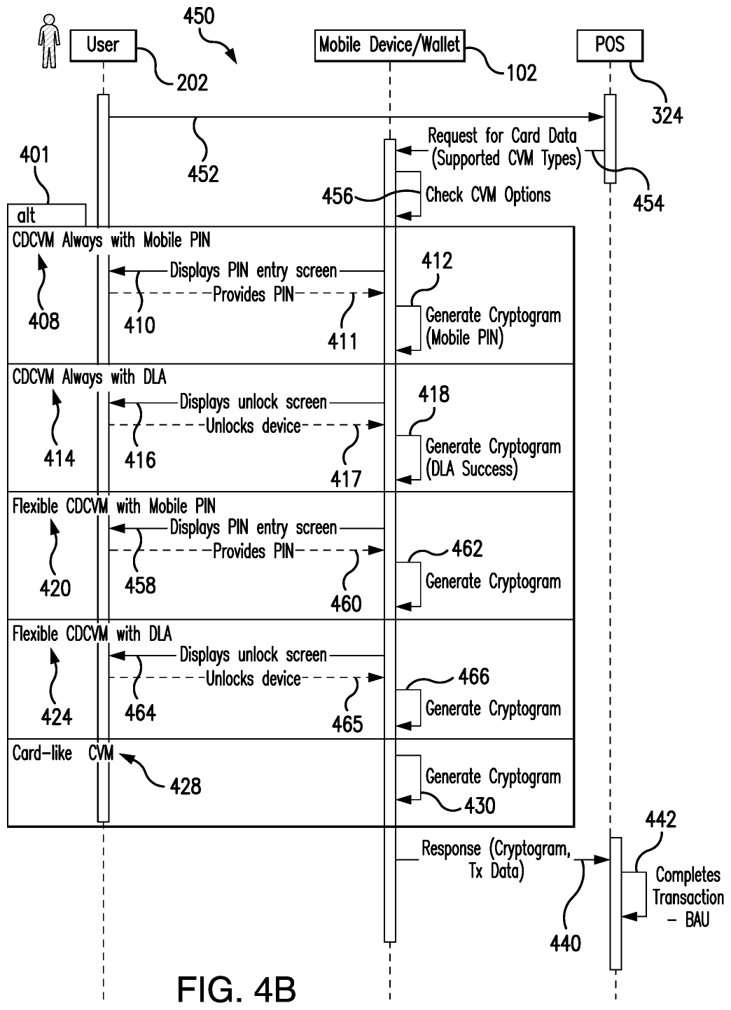

FIG. 4A is a flow diagram 400 illustrating an in-store, low value transaction (LVT), contactless payment transaction process with a default CVM model. A low value transaction is a payment transaction where the transaction amount does not exceed a threshold amount. The threshold amount could be defined by the POS, the consumer device, the wallet, service provider or the issuer. The LVT may also be defined as a low risk transaction (independent of the transaction amount), wherein the risk level could be determined using data analytics, artificial intelligence, and the like, by the payment network, issuer, service provider, TSP, or other entity.

Referring again to FIG. 4A, various types of CVM models are depicted within the box 401, which will be discussed below. In an example, a consumer 202 is in a merchant's retail store and wishes to utilize his or her mobile device 102 to pay for a purchase of item(s) and/or service(s) from a merchant. Thus, the consumer interacts 402 with the POS by, for example, tapping the mobile device 102 on, for example, a contactless reader associated with the POS terminal 324 to initiate an NFC transaction. The POS terminal then transmits 404 a request for payment account data to the mobile device 102. The mobile device then checks 406 for a CVM option (which will be selected from the options shown in box 401). In this example implementation, which is a contactless payment for a low-value transaction (LVT), the default CVM model and default card (which may have been selected during registration) are utilized to make the purchase transaction. Thus, if the default CVM is “CDCVM Always with Mobile Pin” 408 then the user is presented 410 with a personal identification number (PIN) entry screen (not shown). The PIN entry screen may include a request for cardholder verification on the mobile device by entering a mobile PIN. The user next provides 411 the PIN and then the mobile device generates 412 a cryptogram using the mobile PIN and transaction credentials. Next, the mobile device transmits 440 a response to the POS terminal 324 that includes the cryptogram and transaction data. The POS terminal 302 would then complete the transaction 442 via business as usual (BAU) processing (described above, which involves a payment network and the payment card issuer, for example).

In FIG. 4A, if the default CVM is instead “CDCVM Always with DLA” 414 then the user is presented 416 with a consumer device unlock screen which may request the consumer to enter a device PIN, a pattern, biometrics or the like (which is considered a locally-verified CDCVM). The user next provides 417 the unlock data and then the mobile device generates 418 a cryptogram. As mentioned above, the mobile device then transmits 440 a response to the POS terminal 324 that includes the cryptogram and transaction data, where CVM entry information may be provided in the cryptogram. The POS terminal 324 would then complete the transaction 442 via business as usual (BAU) processing (described above, which involves a payment network and the payment card issuer, for example). It should be noted that when using the “CDCVM Always” model, the device, digital wallet, banking application, web browser or the like requests cardholder verification for every transaction.

Referring again to FIG. 4A, if the default CVM is instead “Flexible CDCVM with Mobile PIN” 420 then a mobile PIN is used for authentication, depending on the transaction amount or whether velocity checks pass/fail (if velocity checks are enabled). In this scenario, a CVM (mobile PIN) is always requested if the transaction is a high value transaction (HVT); no CVM is requested for a low value transaction (LVT) (assuming velocity checks are not enabled). It should be understood that a high value transaction (HVT) is a payment transaction where the transaction amount exceeds a predetermined threshold amount. The threshold amount could be defined by the POS, the consumer device, the wallet, SRC system or the issuer. The HVT may also be defined as a high risk transaction (independent of the transaction amount), wherein risk level or risk category (medium risk or higher) could be determined using data analytics, artificial intelligence, and the like, by the payment network, issuer, service manager, TSP, or other entity.

Continuing with this example of a “Flexible CDCVM with mobile PIN” 420, after the user provides the mobile PIN when/if requested, then the mobile device generates 422 or 426 a cryptogram, and transmits 440 a response to the POS terminal 324 that includes the cryptogram and transaction data. The POS terminal 324 would then complete the transaction 442 via business as usual (BAU) processing. It should be noted that, in some implementations, velocity check counters may be enabled for the device or wallet that track such LVTs, which can result in the mobile wallet, device or web site supporting SRC payments, and the like requesting cardholder verification for some LVTs. If velocity checks are enabled, a CVM is also requested for a LVT, if velocity checks fail. It is to be noted that CVM validation for velocity checks is typically performed by the device locally (locally verified CDCVM), not by the wallet/issuer backend or TSP, although this information (velocity checks performed and passed/CVM entry successful) may be provided to the backend system in the application cryptogram. In addition, for some transactions (such as a transit transaction) the mobile wallet, mobile application, mobile device, web wallet or web site supporting SRC payments, and the like may decide not to request cardholder verification based on the MCC, transaction type, and/or amount.

In FIG. 4A, if the default CVM is instead “Flexible CDCVM with DLA” 424 then a DLA is used for authentication, depending on the transaction amount or whether velocity checks pass/fail, if velocity checks are enabled. In this scenario, a CVM (DLA) is always requested if the transaction is a HVT; no CVM is requested for a LVT (assuming velocity checks are not enabled or are enabled and velocity checks pass). Accordingly, after the user provides the CVM when/if requested, then the mobile device generates 422 or 426 a cryptogram, and transmits 440 a response to the POS terminal 324 that includes the cryptogram and transaction data. The POS terminal 324 would then complete the transaction 442 via business as usual (BAU) processing. It should be noted that, in some implementations, velocity check counters may be enabled for the device or wallet that track such low value transactions (LVTs), which can result in the mobile wallet requesting cardholder verification for some LVTs. If velocity checks are enabled, a CVM (typically locally verified CDCVM, i.e. DLA) is also requested for an LVT, if velocity checks fail. In addition, for some transactions (such as a transit transaction) the mobile wallet, mobile device and the like, may decide not to request cardholder verification based on the MCC, transaction type, and/or amount.

Referring yet again to FIG. 4A, if the default CVM is instead “Card-like CVM” 428 then the consumer's mobile device capability of supporting CDCVM is not communicated to the POS terminal 324, and the POS terminal treats the consumer mobile device as a contactless card and requests the appropriate POS-centric CVM (i.e., whatever method that the merchant utilizes to authenticate users of payment cards). Thus, in this LVT example no CVM is requested, and the mobile device generates 430 a cryptogram, and transmits 440 a response to the POS terminal 324 that includes the cryptogram and transaction data. The POS terminal 324 would then complete the transaction 442 via business as usual (BAU) processing. It should be noted that, in some implementations, velocity check counters may be enabled for the device or wallet that track low value transactions (LVTs), which can result in the mobile wallet requesting cardholder verification for some LVTs. If velocity checks are enabled, a CVM (locally verified CDCVM, i.e. DLA) is also requested for a LVT, if velocity checks fail.

FIG. 4B is a flow diagram 450 illustrating an in-store, high value transaction (HVT), contactless payment transaction process with a default CVM model. The same CVM models as shown in FIG. 4A are depicted within the box 401. In this example, a consumer 202 is in a merchant's retail store and wishes to utilize his or her mobile device 102 (e.g. using device hardware and/or a payment application) to pay for a purchase of high value item(s) and/or service(s) from a merchant. Thus, the consumer taps 452 the mobile device 102 on, for example, a contactless reader associated with the POS terminal 324 to initiate an NFC transaction. The POS terminal then transmits 454 a request for payment account data to the mobile device 102 via the receiving device 116. The mobile device then checks 456 for a CVM option (which will be selected from the options shown in box 401) using the CVM validation module 122. In this example implementation, which is a contactless payment for a high-value transaction (HVT), the default CVM model and default payment account (which may have been selected during registration) are utilized to make the purchase transaction. Thus, if the default CVM is “CDCVM Always with Mobile Pin” 408 then the user is presented 410 with a personal identification number (PIN) entry screen on the display device 106 (see FIG. 1), as was the case for the LVT shown in FIG. 4A. The user is prompted to provide a PIN by a message appearing on the display device 106, and the user then provides 411 the PIN (for example, by using the touch screen 106 or an input device 104). The mobile device next generates 412 a cryptogram via the cryptographic module 124 and/or generation module 120. Next, the mobile device transmits 440 a response to the POS terminal 324 using the transmitting device 126 that includes the cryptogram and transaction data. The POS terminal 302 then completes 442 the HVT transaction via business as usual (BAU) processing (described above, which involves a payment network and the payment card issuer, for example).

Referring again to FIG. 4B, if the default CVM is instead “CDCVM Always with DLA” 414 then, as explained above with regard to FIG. 4A, the user is presented 416 with a consumer device unlock screen which may request the consumer to enter a PIN, a pattern, or the like (which is considered a locally-verified CDCVM) using the display device 106, input device 104 or biometric sensor 110. The user next provides 417 the device unlock data and then the mobile device generates 418 a cryptogram. CVM entry information may be provided in the cryptogram. As mentioned above, the mobile device then transmits 440 a response to the POS terminal 324 that includes the cryptogram and transaction data. The POS terminal 324 would then complete the transaction 442 via business as usual (BAU) processing (described above, which involves a payment network and the payment card issuer, for example).

However, in FIG. 4B, if the default CVM is instead “Flexible CDCVM with Mobile PIN” 420 then the mobile device displays 458 a PIN entry screen, and the consumer 202 provides the PIN. The mobile device next generates 462 a cryptogram, or the cloud cryptogram is retrieved from the service manager computer, and then transmits 440 a response to the POS terminal 324 that includes the cryptogram and transaction data. As before, the POS terminal 324 then completes the transaction 442 via business as usual (BAU) processing.

Referring again to FIG. 4B, if the default CVM is “Flexible CDCVM with DLA” 424 then the mobile device 102 displays 464 a device unlock screen to obtain a locally-verified CDCVM. The consumer 202 then unlocks 465 the mobile device 102, and then the mobile device generates 466 a cryptogram. CVM entry information may be provided in the cryptogram. The mobile device 102 then transmits 440 (using the transmitting device 126) a response to the POS terminal 324 that includes the cryptogram and transaction data. The POS terminal 324 then completes the transaction 442 via business as usual (BAU) processing.

Referring yet again to FIG. 4B, if the default CVM is instead “Card-like CVM” 428 then the consumer's mobile device capability of supporting CDCVM is not communicated to the POS terminal 324, and the POS terminal treats the consumer mobile device as a contactless card and requests the appropriate POS-centric CVM (i.e., whatever method that the merchant utilizes to authenticate users of payment cards). Thus, in this HVT example no CVM is requested, and the mobile device generates 430 a cryptogram, and transmits 440 (using the transmitting device 126) a response to the POS terminal 324 that includes the cryptogram and transaction data. The POS terminal 324 would then complete the transaction 442 via business as usual (BAU) processing.

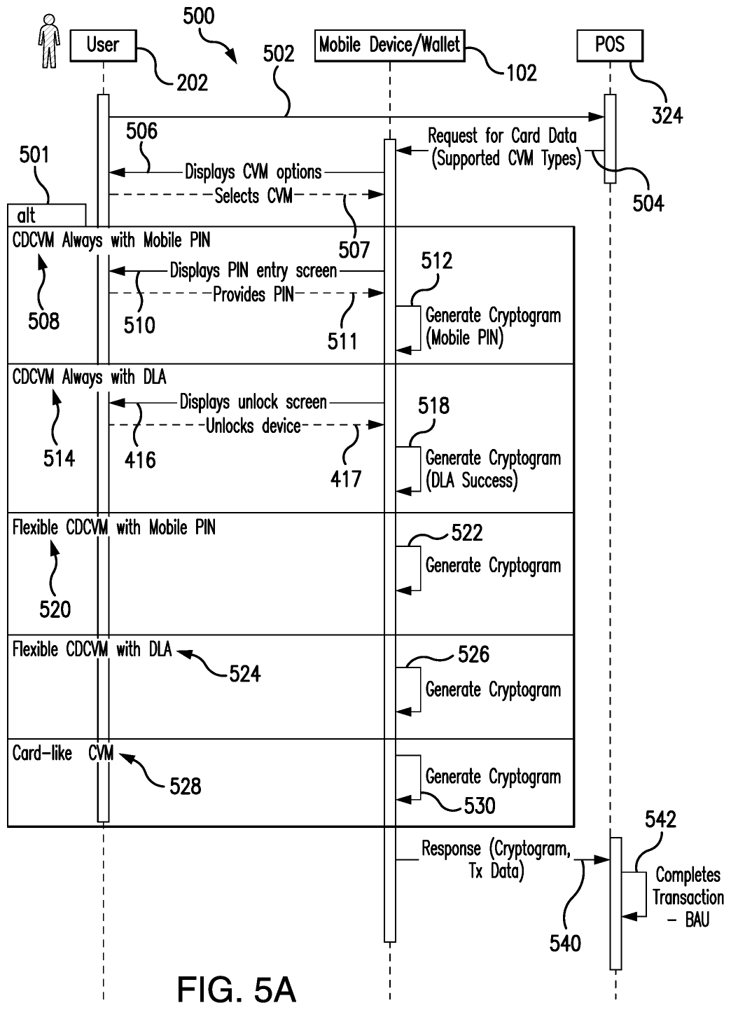

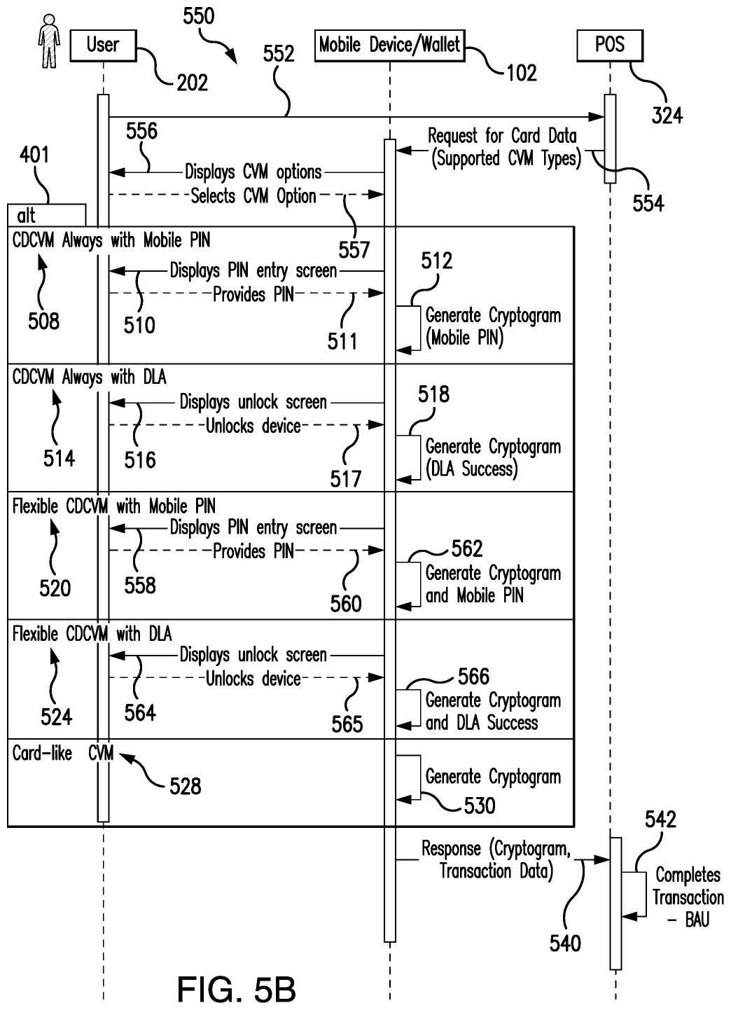

FIG. 5A is a flow diagram 500 illustrating a low value transaction (LVT), payment transaction process (which may be contactless) with on-the-fly CVM model selection by the user. Various types of CVM models for selection by the user are shown within the box 501, wherein all the token payment profile and transaction credentials have already been provisioned into the mobile device 102 during the registration process (otherwise, if a CVM model is changed, relevant credentials would need to be provisioned into the device, which would require internet connectivity). In an example, a consumer 202 is in a merchant's retail store and wishes to utilize his or her mobile device 102 to pay for a purchase of item(s) and/or service(s) from a merchant. Thus, the consumer interacts with the POS terminal by, for example, tapping 502 the mobile device 102 on a contactless reader associated with the POS terminal 324 to initiate an NFC transaction, scanning a QR code, or any other method. The POS terminal then transmits 504 a request for payment account data to the mobile device 102. The mobile device then displays 506 the CVM options (which are included in the box 501). In this example implementation, which is a contactless payment for a low-value transaction (LVT) with on-the-fly CVM selection, a selected CVM model is utilized to make the LVT purchase. Thus, if the user 202 selects 507 “CDCVM Always with Mobile Pin” 508, then the user is presented 510 with a personal identification number (PIN) entry screen (not shown). The PIN entry screen requests entry of a mobile PIN, which the user provides 511. The mobile device then generates 512 a cryptogram, and next transmits 540 a response to the POS terminal 324 that includes the cryptogram and transaction data. The POS terminal 324 then completes the transaction 542 via business as usual (BAU) processing (described above, which may involve a payment network and the payment card issuer, for example).

Referring again to FIG. 5A, if the consumer 202 instead selects “CDCVM Always with DLA” 514 then the user is presented 516 with a consumer device unlock screen which may request the consumer to enter a PIN, a pattern, biometrics, or the like (which is considered a locally-verified CDCVM). The user next provides 517 the unlock data and then the mobile device generates 518 a cryptogram. CVM entry information may be provided in the cryptogram. As mentioned above, the mobile device then transmits 540 a response to the POS terminal 324 that includes the cryptogram and transaction data. The POS terminal 324 then completes the transaction 542 via business as usual (BAU) processing (described above, which involves a payment network and the payment card issuer, for example). It should be noted that when using the “CDCVM Always” model, the mobile device, digital wallet, banking application or the like requests cardholder verification for every type of transaction.

In FIG. 5A, if the user selects “Flexible CDCVM with Mobile PIN” 520 or selects “Flexible CDCVM with Mobile PIN” 524 then a mobile PIN is used as CVM, where CVM is not requested for LVTs, unless velocity checks are enabled and velocity checks fail. Accordingly, once the user provides a CVM when/if requested by the mobile device, then the mobile device generates 522 or 526 a cryptogram that contains a PIN or CVM information, and transmits 540 a response to the POS terminal 324 that includes the cryptogram and transaction data. The POS terminal 324 would then complete the LVT transaction 542 via business as usual (BAU) processing. It should be noted that, in some implementations, the mobile wallet may also have velocity check counters that track such LVTs, which can result in the mobile wallet requesting (typically locally verified) CVM for some LVTs. In addition, for some transactions (such as a transit transaction) the mobile wallet may decide not to request cardholder verification based on the MCC, transaction type, and/or amount.

Referring yet again to FIG. 5A, if the consumer 202 selects “Card-like CVM” 528 then the consumer's mobile device capability of supporting CDCVM is not communicated to the POS terminal 324, and the POS terminal treats the consumer mobile device as a contactless card and requests the appropriate POS-centric CVM (i.e., whatever method that the merchant utilizes to authenticate users of payment cards). Thus, in this LVT example no CVM is requested, and the mobile device generates 530 a cryptogram, and transmits 540 a response to the POS terminal 324 that includes the cryptogram and transaction data. The POS terminal 324 would then complete the transaction 542 via business as usual (BAU) processing.

FIG. 5B is a flow diagram 550 illustrating an in-store, high value transaction (HVT), contactless payment transaction process with on-the-fly CVM model selection by the user. Various types of CVM models for selection by the user are shown within the box 501, wherein all the token payment profile and transaction credentials have already been provisioned into the mobile device 102 during the registration process. In an example, a consumer 202 is in a merchant's retail store and wishes to utilize his or her mobile device 102 to pay for a purchase of item(s) and/or service(s) from a merchant. In one embodiment, the consumer taps 552 the mobile device 102 on, for example, a contactless reader associated with the POS terminal 324 to initiate an NFC transaction. The POS terminal then transmits 554 a request for card data to the mobile device 102. The mobile device then displays 556 the CVM options (which are included in the box 501) to the user. In this example implementation, which is a contactless payment for a high-value transaction (HVT) with on-the-fly CVM selection, a selected CVM model is utilized to make the HVT purchase. Thus, if the user 202 selects 557 “CDCVM Always with Mobile Pin” 508, then the user is presented 510 with a personal identification number (PIN) entry screen (not shown). The PIN entry screen requests entry of a mobile PIN, which the user provides 511. The mobile device then generates 512 a cryptogram, and next transmits 540 a response to the POS terminal 324 that includes the cryptogram and transaction data. The POS terminal 324 then completes the transaction 542 via business as usual (BAU) processing (described above, which may involve a payment network and the payment card issuer, for example).

Referring again to FIG. 5B, if the consumer 202 instead selects “CDCVM Always with DLA” 514 then the user is presented 516 with a consumer device unlock screen which may request the consumer to enter a PIN, a pattern, or the like (which is considered a locally-verified CDCVM). The user next provides 517 the unlock data and then the mobile device generates 518 a cryptogram. As mentioned above, the mobile device then transmits 540 a response to the POS terminal 324 that includes the cryptogram and transaction data. The POS terminal 324 then completes the transaction 542 via business as usual (BAU) processing (described above, which involves a payment network and the payment card issuer, for example). It should be noted that when using the “CDCVM Always” model, the digital wallet, banking application or the like requests cardholder verification for every type of transaction (including a transit transaction, wherein the user is obtaining access to a transit system via a turnstile, for example).

However, in FIG. 5B, if the consumer 202 instead selects “Flexible CDCVM with Mobile PIN” 520 then the mobile device displays 558 a PIN entry screen, and the consumer 202 provides 560 the PIN. The mobile device next generates 562 a cryptogram, and then transmits 540 a response to the POS terminal 324 that includes the cryptogram and transaction data. As before, the POS terminal 324 then completes the transaction 542 via business as usual (BAU) processing.

Referring again to FIG. 5B, if the consumer 202 instead selects “Flexible CDCVM with DLA” 524 then the mobile device 102 displays 564 a device unlock screen to obtain a locally-verified CDCVM. The consumer 202 then unlocks 565 the mobile device 102, and then the mobile device generates 566 a cryptogram. The mobile device 102 then then transmits 540 a response to the POS terminal 324 that includes the cryptogram and transaction data. The POS terminal 324 then completes the transaction 542 via business as usual (BAU) processing.

Referring yet again to FIG. 5B, if the selected CVM is instead “Card-like CVM” 528 then the consumer's mobile device capability of supporting CDCVM is not communicated to the POS terminal 324, and the POS terminal treats the consumer mobile device as a contactless card and requests the appropriate POS-centric CVM (i.e., whatever method that the merchant utilizes to authenticate users of payment cards). Thus, in this HVT example no CVM is requested, and the mobile device generates 530 a cryptogram, and transmits 540 a response to the POS terminal 324 that includes the cryptogram and transaction data. The POS terminal 324 would then complete 542 the transaction via business as usual (BAU) processing.

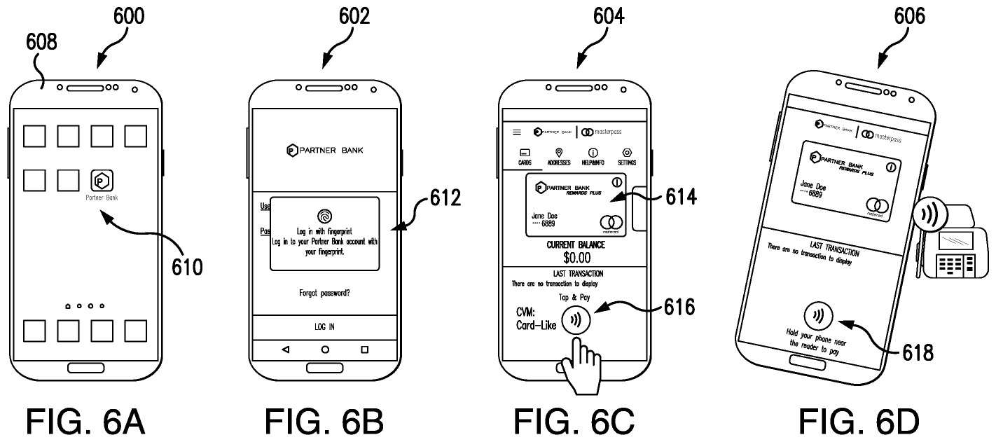

FIGS. 6A-6D illustrate examples of screen displays (or screen shots) 600, 602, 604 and 606 of mobile device user interface screens to illustrate a mobile device contactless transaction user experience in accordance with some embodiments. FIG. 6A depicts a user mobile device 608 or smartphone that includes a screen shot 600 of the display screen 610 showing various icons which can be selected by the user to perform various functions. When the consumer wishes to conduct a purchase transaction, the consumer launches a mobile payment application (MPA), banking application, or the like and may be presented with a user login screen 612 as shown in the screenshot 602 FIG. 6B, which in this example prompts the user to “Log in with fingerprint” to his or her mobile wallet. In some implementations, the user can login via other types of existing device or application credentials, such as by providing other DLA (device unlock pattern, passcode, biometric data (such as iris scan data or facial data) and the like), or by using a mobile/wallet PIN, as required by the MPA. Depending on the wallet security preferences, the user may not be requested to provide a CVM for login.

Next, after the user selects a payment account and a CVM model, as shown in the screenshot 604 of FIG. 6C, a representation of the payment card 614 is displayed along with e.g. an option to “Tap and Pay” 616 and/or “Pay with QR”. As shown, the user selects to “Tap & Pay” using a “card-like” CVM for the selected card (or may have been the default selection). The user may then be directed to “Hold your phone near the reader to pay” as shown in the screen shot 606 of FIG. 6D. Processing then continues in a manner of a card present transaction.

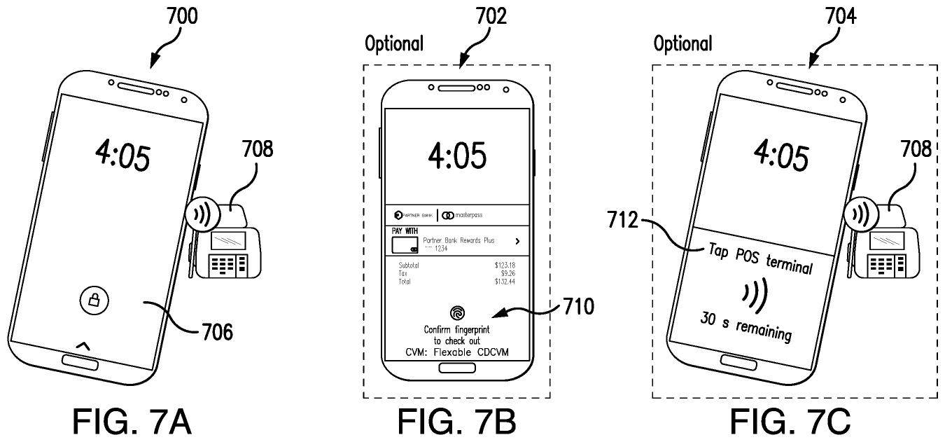

FIGS. 7A-7C are examples of screen displays (or screen shots) 700, 702 and 704 of two different contactless transaction user experiences that can occur when the mobile device is locked in accordance with some embodiments. In FIG. 7A, the consumer has turned on but has not unlocked the mobile device (which is therefore showing a “locked” screen 708) and tapped it on a contactless reader device 708. In this implementation, where CVM is not required/requested by the consumer device, the merchant's NFC reader is able to receive the necessary payment account information and process the payment transaction. However, in an alternative embodiment, after tapping the unlocked device on the reader 708, as shown in the screenshot 702 of FIG. 7B, the consumer is prompted to enter a CVM (for example, a mobile PIN, biometric data, etc.). In the screenshot 702, the consumer has been asked 710 to “Confirm fingerprint to pay.” In some embodiments, the consumer may also be provided with the option to change the payment card and/or the CVM for the payment. In other embodiments, after providing the CVM, as shown in the screenshot 704 of FIG. 7C, the consumer may be prompted 712 to tap the NFC reader 708 with the mobile device a second time on order to complete the transaction. CVM entry is requested depending on the CVM model selected and whether velocity checks have been enabled and if velocity checks pass/fail.

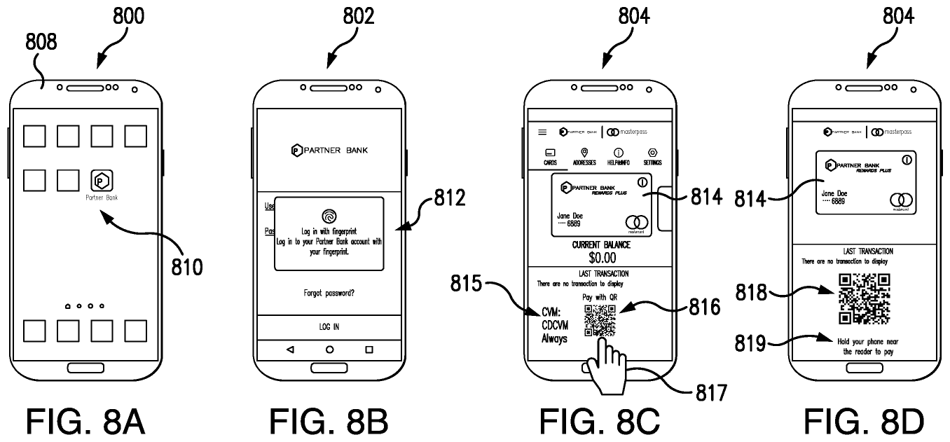

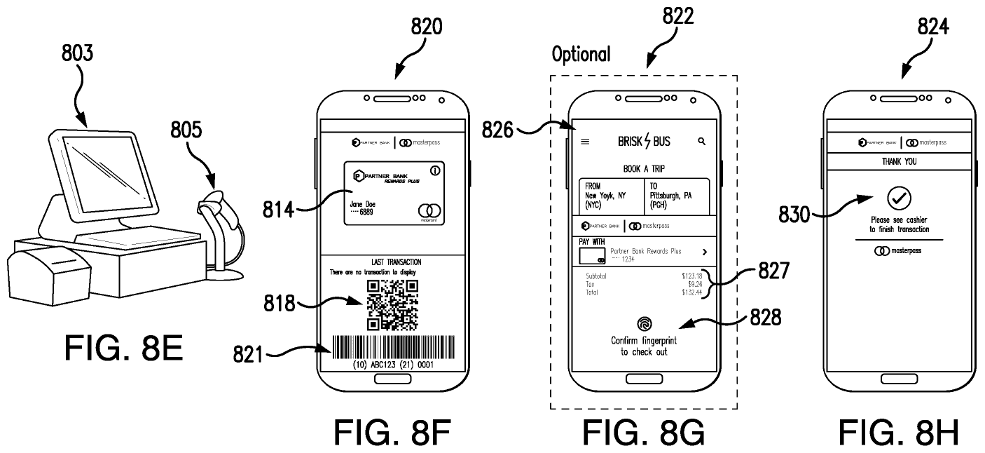

FIGS. 8A-8H illustrate examples of screen displays (or screen shots) 800, 802, 804, 806, 820, 822 and 824 of mobile device user interface screens to illustrate an in-store QR code transaction user experience in accordance with some embodiments. FIG. 8A depicts a user mobile device 808 or smartphone screenshot 800 depicting various icons on a display screen 810 which can be selected by the consumer to perform various functions. When the consumer wishes to conduct a purchase transaction, the consumer launches a mobile payment application (MPA), banking application, or the like and is presented with a user login screen 812 as shown in the screenshot 802 FIG. 8B, which in this example prompts the user to “Log in with fingerprint” to his or her mobile wallet. In some implementations, the user can login via other types of existing device or application credentials, such as by providing other DLA (device unlock pattern, passcode, biometric data (such as iris scan data or facial data) and the like), or by using a mobile/wallet PIN, as required by the MPA. Depending on the wallet security preferences, the user may not be requested to provide a CVM for login.

Next, after the user selects a payment account and a CVM model, as shown in the screenshot 804 of FIG. 8C, a representation of the payment account data 814 is displayed along a CVM model 815 of “CDCVM Always” (which may have been the default CVM) with an option to “Tap & Pay” and/or “Pay with QR” 816. In this example, the consumer selects 817 to pay with QR code option, and then the screen shot 806 of FIG. 8D appears. In FIG. 8D, a QR code 818 appears along with instructions 819 to “Display your QR code to merchant QR code reader.” The QR code may include the payment information and cryptogram information required for the transaction. Next, FIG. 8E shows a barcode scanner 805 associated with the merchant's POS terminal 803. The barcode scanner 805 can then be used by the merchant to read the QR code 818 (as shown in FIG. 8F) or the two-dimensional barcode 821. Processing then continues in a manner of a “CDCVM Always” transaction (selected/supported CVM model in this example), and in some embodiments the consumer receives a push notification as shown in the screenshot 822 of FIG. 8G to confirm payment. In particular, the push notification may include information identifying the transaction 826, purchase transaction information 827, and a prompt 828 for the consumer to enter a CVM (such as a mobile PIN, biometric data, etc.). In some embodiments, the confirmation requirement may be omitted if the consumer already provided a CVM in FIG. 8B. Next, the consumer is provided with a confirmation message 830 as shown in the screenshot 824 of FIG. 8H.

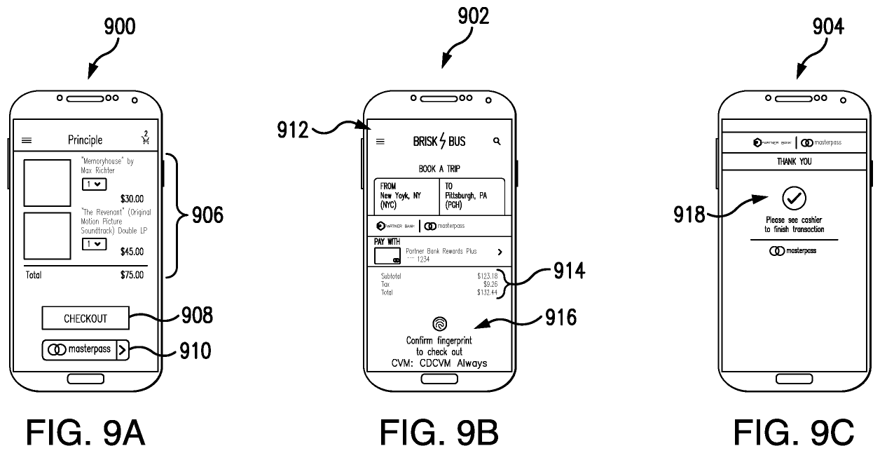

FIGS. 9A-9C illustrate examples of screen displays (or screen shots) of mobile device user interface screens 900, 902 and 904 associated with an online payment transaction, such as a secure remote commerce (SRC) or digital secure remote payment (DSRP) payment transaction user experience in accordance with some embodiments. The consumer selects items for purchase, which are placed in a virtual shopping cart and displayed 906 along with options to checkout 908, e.g. using a digital wallet 910 or secure remote commerce (SRC). The consumer selects “checkout” on a merchant website or merchant app using e.g. a digital wallet or SRC, and then may be directed to the digital wallet or SRC system, where available payment account list, shipping address list and CVM list may be displayed for selection. In addition, an option to add a payment account, and/or shipping address may be provided. The user then selects a payment account, shipping address and a CVM method (not shown), or adds a payment account, shipping address and CVM model manually. Details concerning the transaction 912, payment transaction information 914, and a prompt to “Confirm fingerprint to check out” 916 are then displayed to the consumer, as shown in the screenshot 902 of FIG. 9B. If applicable for the CVM model, the user is requested to enter a CVM (in this example, by providing her fingerprint, but could also be a mobile PIN, DLA, wallet login, etc.) and/or an OTP code (if requested and/or applicable), a confirmation message 918 is provided, as shown in the screenshot 904 of FIG. 9C. If requested, after the CVM is provided by the consumer and verified by the mobile device, digital wallet, banking application, SRC system or the like, the selected/entered payment data is then provided to the merchant system and the user is redirected to the merchant website or merchant application to confirm the transaction.

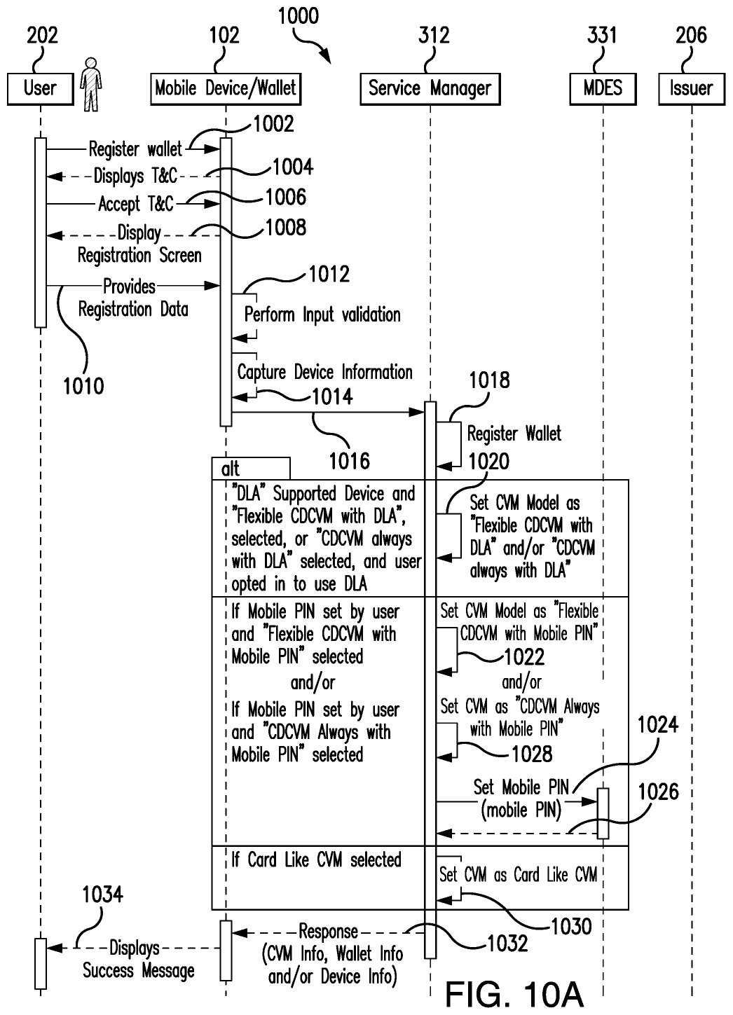

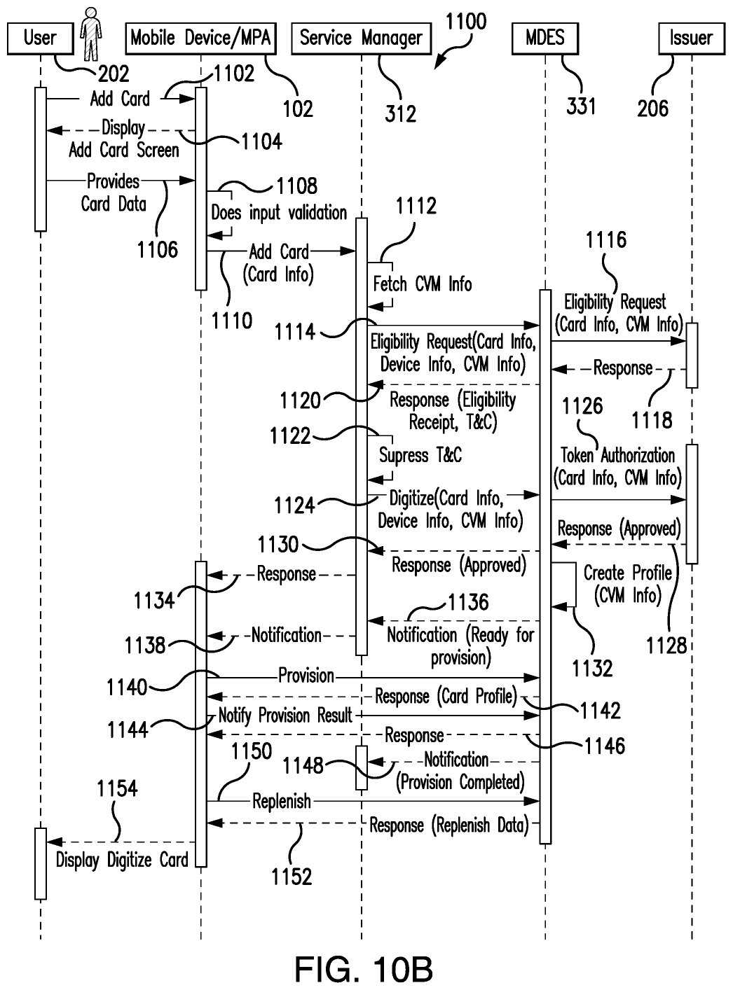

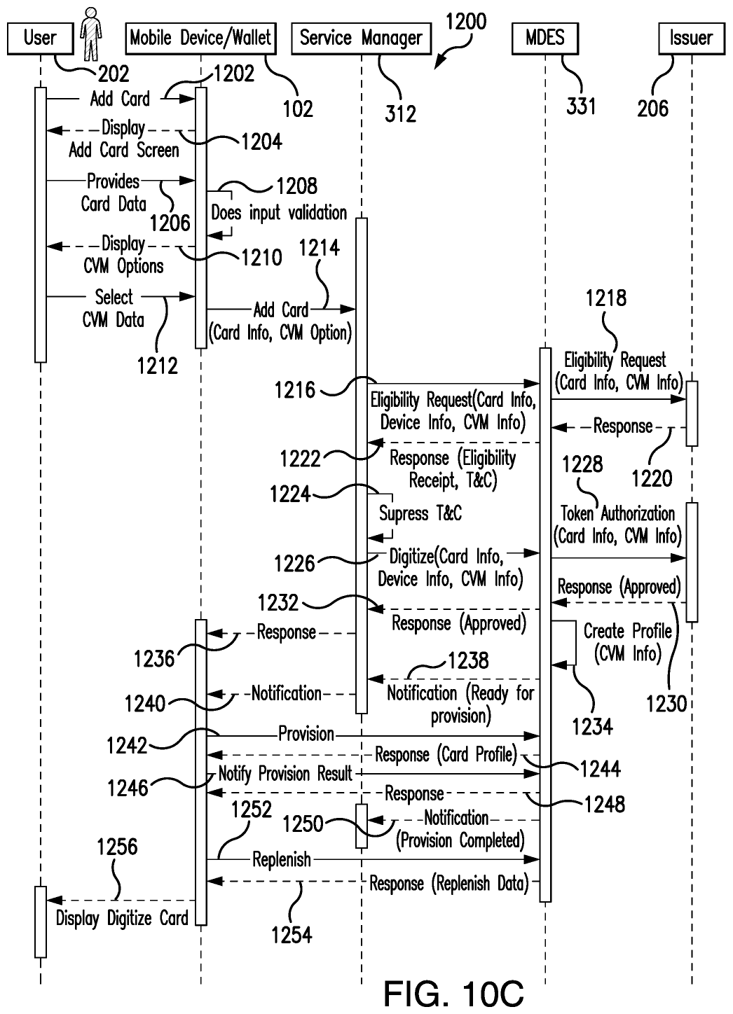

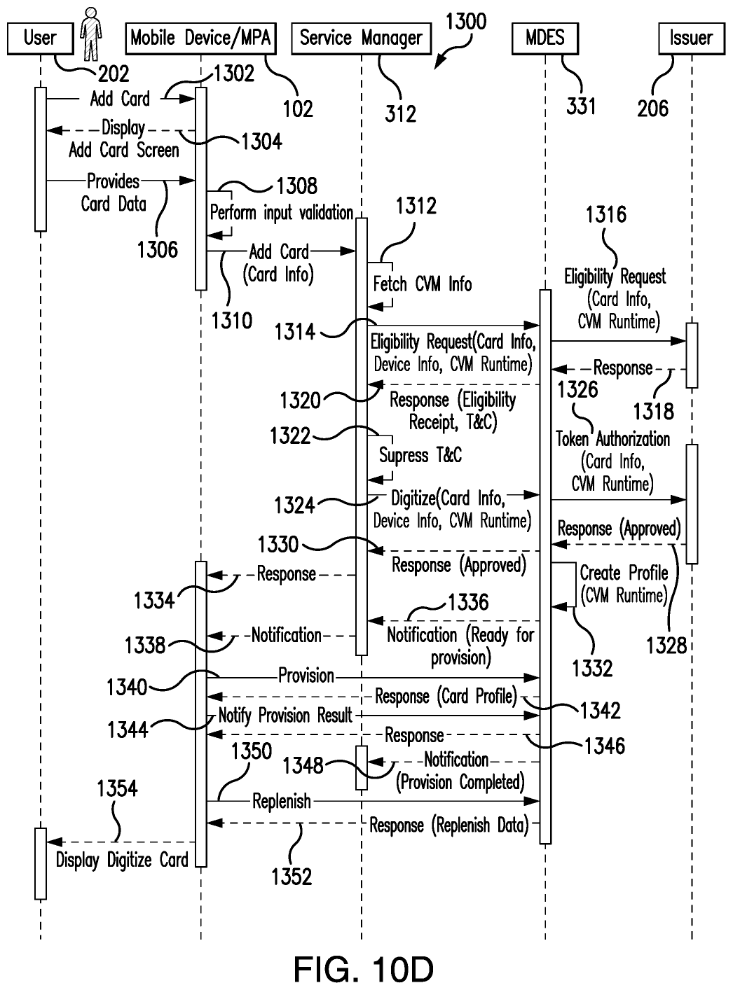

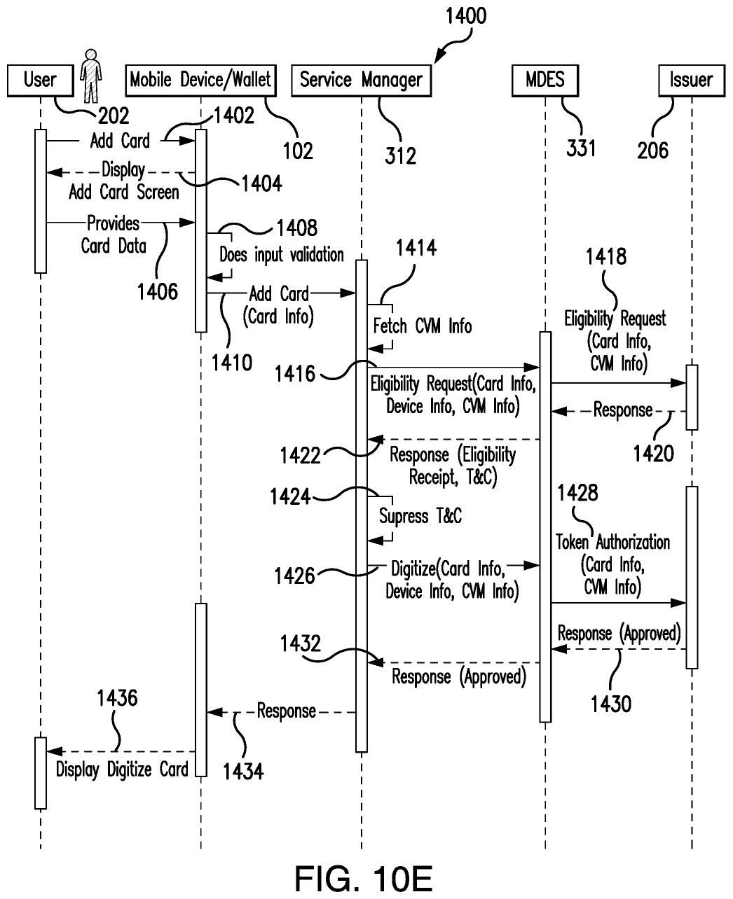

FIG. 10A is a flow diagram illustrating an SRC, digital wallet, mobile device or the like registration process 1000 with digital by default provisioning, and with CVM model selection by the issuer or service manager or service provider, in accordance with methods described herein. As mentioned above, in order for a user 202 to conduct tokenized purchase transactions using her mobile device 102, she must first enable/activate SRC or register her digital wallet, banking application or the like (in some cases there is no need for a wallet, or it is already installed on the consumer's mobile device 102 by default, or which may be downloaded from an authorized party such as a mobile application store, such as the Google Play™ Store, the App Store™, and the like). Thus, the cardholder 202 launches 1002 her mobile wallet application (or mobile banking application supporting SRC or mobile device enabled for SRC, or web wallet application), and then the mobile device 102 displays 1004 a “Terms and Conditions” message on a display screen (not shown). After the cardholder 202 accepts 1006 the “Terms and Conditions,” a consumer registration screen is displayed 1008, which includes information requests for entry by the cardholder. For example, consumer or cardholder registration information may include data such as the cardholder's name, email address, phone number, billing address, and the like. In addition, the consumer may be prompted to add a payment method (not shown), such as a credit card account number or debit card account number. An activation code (provided previously by the issuer FI 206 to the consumer 202) may also be requested to be entered into the digital wallet, banking application or the like from the cardholder in order to activate the digital wallet, banking application or the like or to add a payment method. The activation code could be sent by the issuer or service manager or service provider via separate SMS, email, and the like, or the consumer may be requested to call a customer service representative (CSR) to verify that the consumer is the actual cardholder. Alternatively, the payment method and cardholder information may also be provided by the issuer FI after the consumer has authenticated himself or herself against the issuer (e.g., using online/mobile banking credentials), instead of requesting it from the consumer.

Referring again to FIG. 10A, after the cardholder or user 202 provides 1010 her registration data to the mobile device (that may be running a digital wallet, banking application or the like), the mobile device 102 (or digital wallet, banking application or the like running on the mobile device) then performs input validation 1012, captures device information 1014, and transmits 1016 the device information and cardholder registration data to the service manager computer 312 (which may be, for example, a wallet server provider, or an SRC system or the like) using the transmitting module 126 (FIG. 1). The service manager computer 312 then registers 1018 the digital wallet, banking application or the like or enables SRC on the mobile device(s). In some embodiments, if multiple CVM models have been enabled by the Issuer FI or by the wallet service provider, then all eligible CVM methods would be available to the consumer or cardholder. In this case, all token payment credential provisioning occurs automatically (digital-by-default provisioning), wherein the user does not manually add a card or select the CVM. However, in other implementations, only one CVM model may be available to the consumer. In either case, the Issuer FI or service provider may set the default CVM model, and in some implementations the cardholder is able to change the default CVM method after registration.

Thus, in FIG. 10A, after the service manager computer 312 registers 1018 the mobile device for SRC or the digital wallet, banking application or the like (assuming card-like is not the only supported CVM model) it sets 1020 the CVM model (Flexible CDCVM or CDCVM Always) with device level authentication (DLA) for a DLA-supported mobile device, or sets 1022 (Flexible CDCVM or CDCVM Always) with mobile PIN otherwise. In this latter case, the mobile PIN is transmitted 1024 to the DES computer 331, which may acknowledge 1026 the mobile PIN. In implementations where the issuer FI, service provider or consumer has opted to support card-like CVM, then the service manager computer 312 sets 1028 the CVM model as “Card-like CVM”, where no mobile PIN or DLA setting is requested from the consumer. In any of the cases explained above, the service manager computer 312 then transmits 1030 a response to the mobile device 102 that includes the CVM information, including the CVM list and default CVM model (indicated by the customer/issuer/service provider), digital wallet and/or device information, and then the mobile device 102 displays 1032 a success message for review by the cardholder 202. The cardholder can now use the mobile device enabled for SRC or the digital wallet, banking application or the like running on the mobile device 120 to conduct purchase transactions.

If the consumer mobile device 102 supports Device Level Authentication (DLA) and the user has opted in using DLA, which may include usage of biometrics (for example, a fingerprint if the consumer mobile device includes a fingerprint sensor) for wallet login and/or for the purpose of making a digital payment, then the consumer may be prompted to provide biometric data (not shown). If Flexible CVCVM with DLA is within the supported CVM list, then the CVM is set (enabled for the device/wallet/wallet instance/payment account). Similarly, if CDCVM Always with DLA is supported, this CVM is set.

Similarly, if the consumer opts in using mobile PIN, then during the registration process, the cardholder is prompted to provide the mobile PIN (not shown). Such a mobile PIN could be valid and/or the same for the entire wallet (referred to as a wallet PIN), wallet instance, for one device, all devices, or valid only for a single payment account. In some implementations, the mobile wallet application may have a one PIN for login (mobile application PIN) and a separate, different PIN (mobile PIN) for payments purposes. If Flexible CVCVM with mobile PIN is within the supported CVM list, then the CVM is set. Similarly, if CDCVM Always with mobile PIN is supported, this CVM is set.

FIG. 10B is a flow diagram illustrating an add payment account by accountholder process 1100 with non-digital by default provisioning, and with no CVM model selection by the cardholder in accordance with methods described herein. The user launches the digital wallet, banking application, web browser or application supporting SRC or the like on his mobile device and indicates 1102 that he wishes to add a payment account. The digital wallet, banking application or the like then causes the mobile device to display 1104 and Add Card/payment account screen, and the cardholder provides 1106 payment account data. The digital wallet, banking application or the like then validates 1108 the input, and transmits 1110 the payment account information to the service manager computer 312 or SRC system. The service manager computer service manager computer then fetches 1112 the CVM information for that mobile device, and transmits 1114 an eligibility request, which may include the payment account information, device information and CVM information, to the DES computer 331. The DES computer 331 transmits 1116 the eligibility request to the Issuer, which then transmits 1118 a response to the DES computer 331 that includes a receipt and “Terms and Conditions.” The DES computer 331 then transmits 1120 the response to the service manager computer 312, which may suppress 1122 the “Terms and Conditions” if already provided in the wallet or banking application, or the like, and then transmits 1124 a tokenization request to the DES computer 331. The DES computer 331 in turn transmits 1126 a token authorization message to the issuer 206 which includes the payment account information and CVM information. If all is in order the issuer transmits 1128 an approval response to the DES computer 331, which transmits 130 a response approved message to the service manager computer 312 and creates 1132 a profile including the CVM information. The service manager computer 312 (wallet server or SRC system) also transmits 1134 the response to the mobile device 102. Next, the DES computer 331 transmits 1136 a notification indicating that it is ready for provisioning, and the forwards 1138 the notification to the mobile device 102. Next, the mobile device 102 transmits 1140 a provisioning request, and then receives 1142 a provisioning response including a payment account profile. The mobile device then transmits 1144 a provisioning result notification to the DES computer 331, which may transmit 1146 a response to the mobile device, but that does transmit 1148 a provisioning completed notification to the service manager computer 312. Next, the mobile device 102 transmits 1150 a replenish message to the DES computer 331, which responds 1152 with replenishment data. Then display device 106 (See FIG. 1) of the mobile device 102 then displays 1154 a digitized payment account message for review by the cardholder 202 (on the banking application or digital wallet running on the mobile device 102).

FIG. 10C is a flow diagram illustrating an add payment account and select CVM by cardholder process 1200 with non-digital by default provisioning in accordance with methods described herein. In some implementations, the user launches the digital wallet, banking application, web browser or the like on his mobile device and indicates 1202 that he wishes to add a payment account. The digital wallet, banking application, web browser or the like then causes the mobile device to display 1204 an Add Payment account screen on the display device 106, and the cardholder provides 1206 payment account data by using the display device 106 (if it is a touch screen) or input device 104. The digital wallet, banking application, web browser or the like then validates 1208 the input, and next displays 1210 the CVM options to the cardholder. The cardholder then selects 1212 a CVM option, and the digital wallet, banking application or the like causes the mobile device to transmit 1214 an Add Payment account request to the service manager computer 312. The service manager computer then transmits 1216 an eligibility request to the DES computer 331, which eligibility request includes the payment account information, device information and the selected CVM information. Next, the DES computer 331 transmits 1218 the eligibility request to the Issuer, which then transmits 1220 a response to the DES computer 331, which may include an eligibility receipt and “Terms and Conditions.” The DES computer 331 then transmits 1222 the response to the service manager computer 312, which may suppress 1124 the “Terms and Conditions” (for example, if the service manager computer 312 or issuer 206 has its' own terms and conditions). The DES computer 331 then transmits 1226 a tokenization request to the DES computer 331, which in turn transmits 1228 a token authorization message to the issuer 206 which includes the payment account information and the selected CVM information. If all is in order, the issuer transmits 1230 an approval response to the DES computer 331, which transmits 1232 a response approved message to the service manager computer 312 and creates 1234 a profile including the CVM information. The service manager computer 312 also transmits 1236 the response to the mobile device 102. Next, the DES computer 331 transmits 1238 a notification indicating that it is ready for provisioning, and the service manager computer 312 forwards 1240 the notification to the mobile device 102. Next, the mobile device 102 transmits 1242 a provisioning request to the DES computer 331, and then receives 1244 a provisioning response including a payment account profile. The mobile device 102 then transmits 1246 a provisioning result notification to the DES computer 331 using the transmitting device 126, which may transmit 1248 a response to the mobile device, and which does transmit 1250 a provisioning completed notification to the service manager computer 312. Next, the mobile device 102 transmits 1252 a replenish message to the DES computer 331, which may respond 254 with replenishment data. Then the display device 106 (see FIG. 1) of the mobile device (digital wallet, banking application or the like running on the mobile device 102) then displays 1256 a digitized card or payment account message for review by the cardholder 202.

FIG. 10D is a flow diagram illustrating an add payment account process 1300 with non-digital by default flow with no CVM model selection by the cardholder (the issuer or service provider selects the CVM model) in accordance with methods described herein. In the embodiment shown, the user launches the digital wallet, banking application or the like on his mobile device and indicates 1302 that he wishes to add a payment card. The digital wallet, banking application or the like then causes the mobile device to display 1304 an Add payment account screen, and the cardholder provides 1306 payment account data. The digital wallet, banking application or the like then validates 1308 the input, and then transmits 1310 an Add Payment account request with payment account data to the service manager computer 312. The service manager computer 312 (or SRC system) then fetches 1312 the CVM information for that mobile device, and transmits 1314 an eligibility request to the DES computer 331, which eligibility request includes the payment account information, device information and CVM runtime data. Next, the DES computer 331 transmits 1316 the eligibility request to the Issuer, which then transmits 1318 a response to the DES computer 331. The response 1318 may be a positive response to the eligibility request indicating that the cardholder's payment account can be added to the mobile wallet application running on the consumer's mobile device. In some implementations, the response 1318 may include an eligibility receipt and a “Terms and Conditions” recitation. The DES computer 331 then transmits 1320 the response to the service manager computer 312, which may include the eligibility receipt and the “Terms and Conditions.” In some embodiments, the service manager computer 312 may suppress 1322 the “Terms and Conditions” recitation (for example, if the service manager computer 312 or issuer 206 has its' own terms and conditions).

Referring again to FIG. 10D, the service manager computer 312 next transmits 1324 a tokenization request to the DES computer 331, which in turn transmits 1326 a token authorization message to the issuer 206 which includes the payment account information and the CVM runtime data. If all is in order, the issuer transmits 1328 an approval response to the DES computer 331, which transmits 1330 a response approved message to the service manager computer 312 and creates 1332 a profile including the CVM runtime data. The service manager computer 312 also transmits 1334 the response to the mobile device 102. Next, the DES computer 331 transmits 1336 a notification indicating that it is ready for provisioning, and the service manager computer 312 forwards 1338 the notification to the mobile device 102. Next, the mobile device 102 transmits 1340 a provisioning request to the DES computer 331, and then may receive 1342 a provisioning response including a payment account profile. Next, the mobile device 102 transmits 1344 a provisioning result notification to the DES computer 331, which may transmit 1346 a response to the mobile device 102, and which does transmit 1348 a provisioning completed notification to the service manager computer 312. Next, the mobile device 102 transmits 1350 a replenishment request to the DES computer 331, which may respond 1352 with replenishment data, including transaction credentials such as session keys or single use keys. Then the display device of the mobile device (on the digital wallet, banking application and the like running on the mobile device 102) then displays 1354 a digitized payment account message for review by the cardholder 202.

FIG. 10E is a flow diagram illustrating an add payment account process 1400 for web wallet or SRC accountholder (e.g. registered from an online banking website) with non-digital by default provisioning, and with no CVM model selection by the cardholder in accordance with methods described herein. As shown, the user logs into the web wallet or logs into online banking on his mobile device and indicates 1402 that he wishes to add a payment account. The web wallet or banking website and the like then causes the mobile device to display 1404 an Add Payment account screen, and the cardholder provides 1406 payment account data. The web wallet, banking website and the like then validates 1408 the input, and then the mobile device 102 transmits 1410 an Add Payment account request with payment account data to the service manager computer 312. The service manager computer 312 then fetches 1414 CVM information and transmits 1416 an eligibility request to the DES computer 331, which eligibility request includes the payment account information, device information and the CVM information. Next, the DES computer 331 transmits 1418 the eligibility request to the Issuer, which then transmits 1420 a response to the DES computer 331, which may include an eligibility receipt and “Terms and Conditions.” The DES computer 331 then transmits 1422 the response to the service manager computer 312, which may suppress 1424 the “Terms and Conditions” (for example, if the service manager computer 312 or issuer 206 has its' own terms and conditions). The service manager computer 312 then transmits 1426 a tokenization request to the DES computer 331, which in turn transmits 1428 a token authorization message to the issuer 206 which includes the payment account information and the CVM runtime data. If all is in order, the issuer transmits 1430 an approval response to the DES computer 331, which in turn transmits 1432 the approval response message to the service manager computer 312, which transmits 1434 the approval response to the mobile device 102. Next, the web wallet or banking website running on the mobile device 102 then displays 1436 a digitized payment account message for review by the cardholder 202.

The systems and processes disclosed herein result in the support of multiple CVM models in digital payments of user interfaces for utilizing contactless (e.g., NFC and QR codes, or any other type of wireless communications technology, such as Bluetooth, WiFi and the like) for in-store (M/chip, magstripe and DSRP), in app and online (SRC, DSRP) payments with a single wallet implementation. In addition, the owner and/or operator of one or more components for conducting digital wallet payment transactions benefits from reduced implementation, operational and maintenance costs and increased customer stickiness by providing a seamless user experience to their consumers. In addition, implementation of such multi-CVM supported wallet payments serves to accelerate the deployment and scale of utilizing a tokenization platform such as a digital enablement system (DES) computer while also increasing payment security due to the use of tokenization by leveraging the DES and/or cloud based payments compliant trusted service provider with CVM. In addition to the security benefits, in some embodiments the processes disclosed herein adhere to global standards for electronically securing payment credentials, and therefore are cost effective because existing payment account infrastructure can be used (such as existing payment card networks). Accordingly, such implementations are interoperable and scalable.

A payments processing company, such as Mastercard International Incorporated, benefits due to supporting of multiple CVM models within the same wallet implementation or digital payments project, by reducing the implementation complexity, cost and burden to issuers and/or wallet service providers from an increase in adoption of Mastercard Digital Enablement Services (MDES), and from bolstering their leadership in digital payments while increasing their market share of digital payments. The consumer benefits by being provided with a seamless purchase transaction user experience by being able to utilize a CVM model that suits their needs.

As used herein and in the appended claims, the term “computer” should be understood to encompass a single computer or two or more computers in communication with each other or a computer network or computer system. In addition, as used herein and in the appended claims, the term “processor” should be understood to encompass a single processor or two or more processors in communication with each other. Moreover, as used herein and in the appended claims, the term “memory” should be understood to encompass a single memory or storage device or two or more memories or storage devices. Such a memory and/or storage device may include any and all types of non-transitory computer-readable media, with the sole exception being a transitory, propagating signal.

The flow charts and descriptions thereof herein should not be understood to prescribe a fixed order of performing the method steps described therein. Rather, the method steps may be performed in any order that is practicable. In addition, the flow charts described herein should not be understood to require that all steps or elements be practiced in every embodiment. For example, one or more elements or steps may be omitted in some embodiments.

Although the present disclosure describes specific exemplary embodiments, it should be understood that various changes, substitutions, and alterations apparent to those skilled in the art can be made to the disclosed embodiments without departing from the spirit and scope of the disclosure as set forth in the appended claims.

What is claimed is:

1. A method permitting a cardholder to select a cardholder verification method (CVM) during a secure transaction comprising:
receiving, by a consumer mobile device running a mobile payment application via an input component from a cardholder, selection of a payment account and an instruction to pay via one of contactless, barcode, SRC or digital secure remote payment (DSRP);
transmitting, by the consumer mobile device to a merchant device, a request for a secure transaction;
receiving, by the consumer mobile device from the merchant device, a request for payment account data;
displaying, by the consumer mobile device via a display component, a plurality of cardholder verification methods (CVMs) for selection by a cardholder;
receiving, by the consumer mobile device via an input component, selection of a CVM;
prompting, by the consumer mobile device via the mobile payment application, the cardholder to provide cardholder identification data in accordance with the selected CVM;
receiving and authenticating, by the consumer mobile device, the cardholder identification data from the cardholder;
generating, by the consumer mobile device, a cryptogram in accordance with the selected CVM; and
transmitting, by the consumer mobile device to the merchant device, transaction data including payment account data and the cryptogram.

2. The method of claim 1, further comprising:
receiving, by the consumer mobile device, a transaction completed confirmation message; and
displaying, by the consumer mobile device, the transaction completed confirmation message on the display component.

3. The method of claim 1, wherein the plurality of cardholder verification methods (CVMs) comprises at least two of: on-consumer-device CVM (CDCVM) always with mobile personal identification number (PIN), CDCVM always with device-level authentication (DLA), flexible CDCVM with mobile PIN, flexible CDCVM with DLA, and card-like CVM.

4. The method of claim 1, wherein the transaction data further comprises at least one of token account information, an M/Chip application cryptogram, M/Chip data, a Mag stripe application cryptogram, and track 2 data.

5. A mobile device configured for permitting a cardholder to select a cardholder verification method (CVM) during a secure transaction comprising:
a mobile device processor;
a display component operably connected to the mobile device processor;
an input component operably connected to the mobile device processor; and
a storage device operably connected to the mobile device processor, wherein the storage device comprises a mobile wallet application and instructions causing the mobile device processor to:
receive, via the input component from a cardholder, selection of a payment account and an instruction to pay via one of contactless, barcode, SRC or digital secure remote payment (DSRP);
transmit a request for a secure transaction to a merchant device;
receive a request for payment account data from the merchant device;
display, via the display component, a plurality of cardholder verification methods (CVMs) for selection by a cardholder;
receive, via the input component, selection of a CVM;
prompt the cardholder to provide cardholder identification data in accordance with the selected CVM;
receive and authenticate the cardholder identification data from the cardholder;
generate a cryptogram in accordance with the selected CVM; and
transmit transaction data including payment account data and the cryptogram to the merchant device.

6. The apparatus of claim 5, wherein the storage device comprises further instructions causing the mobile device processor to:
receive a transaction completed confirmation message; and
display the transaction completed confirmation message on the display component.

7. The apparatus of claim 5, wherein the plurality of cardholder verification methods (CVMs) comprises at least two of: on-consumer-device CVM (CDCVM) always with mobile personal identification number (PIN), CDCVM always with device-level authentication (DLA), flexible CDCVM with mobile PIN, flexible CDCVM with DLA, and card-like CVM.

8. The apparatus of claim 5, wherein the transaction data further comprises at least one of token account information, an M/Chip application cryptogram, M/Chip data, a Mag stripe application cryptogram, and track 2 data.

9. A method for adding a payment account to a mobile device payment application comprising:
receiving, by a service manager computer from a consumer mobile device, an add payment account request from a cardholder to add a payment account to one of a mobile payment application, a web wallet, or a web page supporting secure remote commerce (SRC), the add payment account request comprising payment account data;
fetching, by the service manager computer, cardholder verification method (CVM) information for the consumer's mobile device from a database;
transmitting, by the service manager computer to a digital enablement service (DES) computer, an eligibility request comprising payment account information, consumer mobile device information, and CVM information;
receiving, by the service manager computer from the DES computer, a positive response to the eligibility request indicating that the payment account can be added to the mobile wallet application;
transmitting, by the service manager computer to the DES computer, a tokenization request;
receiving, by the service manager computer from the DES computer, a tokenization approved message;
creating, by the service manager computer, a cardholder profile comprising CVM runtime data;
transmitting, by the service manager computer to the mobile device, the tokenization approved message.

10. The method of claim 9, further comprising:
receiving, by the service manager computer from the DES computer, a notification indicating readiness for provisioning;
transmitting, by the service manager computer, the notification to the consumer's mobile device; and
receiving, by the service manager computer from the DES computer, notification that provisioning to the consumer's mobile device completed.

11. The method of claim 9, wherein the positive response to the eligibility request comprises an eligibility receipt and a “Terms and Conditions” recitation.

12. The method of claim 11, further comprising suppressing, by the service manager computer, the “Terms and Conditions” recitation when at least one of a trusted service manager and an issuer financial institution has its' own terms and conditions.

13. A service manager computer configured for adding a payment account to a mobile device payment application comprising:
a service manager computer processor; and
a service manager computer storage device operably connected to the service manager computer processor, wherein the service manager computer storage device comprises instructions causing the service manager computer processor to:
receive an add payment account request from a consumer mobile device to add a payment account to one of a mobile payment application or web wallet, the add payment account request comprising payment account data;
fetch cardholder verification method (CVM) information for the consumer's mobile device;
transmit an eligibility request to a digital enablement service (DES) computer, the eligibility request comprising payment account information, consumer mobile device information, and CVM information;
receive a positive response to the eligibility request from the DES computer indicating that the payment account can be added to the mobile wallet application;
transmit a tokenization request to the DES computer;
receive a tokenization approved message from the DES computer;
create a cardholder profile comprising CVM runtime data; and
transmit the tokenization approved message to the mobile device.

14. The apparatus of claim 13, wherein the service manager computer storage device further comprises instructions causing the service manager computer processor to:
receive a notification from the DES computer indicating readiness for provisioning;
transmit the notification to the consumer's mobile device; and
receive a notification from the DES computer that provisioning to the consumer's mobile device completed.

15. The apparatus of claim 13, wherein the positive response to the eligibility request comprises an eligibility receipt and a “Terms and Conditions” recitation.

16. The apparatus of claim 15, wherein the service manager computer storage device further comprises instructions causing the service manager computer processor to suppress the “Terms and Conditions” recitation when at least one of a trusted service manager and an issuer financial institution has its' own terms and conditions.
